(19) United States
(12) Patent Application Publication
(10) Pub. No.: US 2009/0147196 A1
(43) Pub. Date: Jun. 11, 2009

(54) FUNCTIONAL FILM AND DISPLAY APPARATUS

(76) Inventors: Wataru Horie, Osaka-shi (JP); Mitsuaki Kumazawa, Kitakyusyu-shi (JP); Masaki Hayashi, Himeji-shi (JP)

Correspondence Address: BIRCH STEWART KOLASCH & BIRCH, PO BOX 747, FALLS CHURCH, VA, 22040-0747, US

(21) Appl. No.: 12/275,137

(22) Filed: Nov. 20, 2008

(30) Foreign Application Priority Data
Nov. 21, 2007 (JP) 301619/2007

(51) Int. Cl. G02F 1/1333; G02B 1/10; B05D 5/06; C09D 113/00

(52) U.S. Cl. 349/122; 359/586; 427/162; 427/595; 524/556

(57) ABSTRACT

A functional film comprises a substrate film and a functional layer formed on the substrate film. In the film, the functional layer is a cured layer of a coated layer, the coated layer contains a resin binder comprising a plurality of resins capable of phase separating from each other, a curable resin(s), and a hollow silica particle, and the hollow silica particles accumulate and gather near a side opposite to a side adjacent to the substrate film.

### FIELD OF THE INVENTION

The present invention relates to a functional film suitably used in liquid crystal displays for various devices or systems such as computers, word processors, and televisions, a process for producing the functional film, a liquid coating composition for forming the functional film, and a display apparatus provided with (or equipped with) the functional film.

### BACKGROUND OF THE INVENTION

In these days, liquid crystal displays have improved remarkably as a display apparatus for television (TV) application or movie display application, and the liquid crystal displays rapidly become popular. The reason for that is, for example, the development of a liquid crystal material having a high-speed responsiveness or the improvement of a drive system such as overdrive has overcome a poor movie display performance, which has been a persistent drawback of liquid crystal displays, and the innovation of industrial technology coping or dealing with the increase in display size has progressed.

These displays are usually subjected to a surface treatment for inhibiting reflection of an exterior light on a surface in order to use the displays for an application requiring a high image quality (e.g., a television and a monitor) and an application in which the displays are used in open air with a strong exterior light (e.g., a video camera). One of the means for inhibiting reflection of an exterior light is an anti-glare treatment. For example, a surface of a liquid crystal display is usually subjected to the anti-glare treatment. By the anti-glare treatment, a finely uneven structure is formed on the surface of the display so as to scatter a light reflected from the surface and blurring of a reflected image on the surface. Therefore, unlike a clear anti-reflection film, the anti-glare layer inhibits the reflected images of viewer and background, and the light reflected on the anti-glare layer hardly tends to interfere with a projected image. Further, a low-reflective anti-glare layer which contains an anti-glare layer and a low-refraction-index layer coated thereon can reduce reflection greatly by blurring a reflected image and reducing the light intensity of the blurred image, thereby producing a high-definition image quality.

For example, Japanese Patent Application Laid-Open No. 235198/2006 (JP-2006-235198A, Claims, and Paragraph Nos. [0066], [0067], [0082], [0090], [0091], [0096], and [0097]) discloses an optical film comprising a support and a thin film layer formed thereon by coating a composition containing a fine particle (e.g., a hollow silica) and a binder. The optical film has a SP value [(B/A)×100], which is an average ratio of (B) an average particle filling factor relative to (A) an average particle filling factor, of not less than 90% and not more than 333%, where the average particle filling factor (A) is an average particle filling factor in the entirety of the thin film layer, and the average particle filling factor (B) is an average particle filling factor in a region of 30% of a film thickness of the thin film layer on the upper side opposite the support.

This document mentions that the optical film has a transparent support and, if necessary, a hardcoat layer as mentioned below, and one or more layer(s) laminated on the support or hardcoat layer according as factors such as the refraction index, the film thickness, the number of layers and the order of laminating layers so as to reduce a reflectance by optical interference, and that the simplest construction of the low-refraction-index layered product comprises the support and a low-refraction-index layer alone coated thereon. The document discloses a support film/low-refraction-index layer construction, a support film/anti-glare layer/low-refraction-index layer construction, a support film/hardcoat layer/anti-glare layer/low-refraction-index layer construction, and others, as concrete layer constructions. Moreover, this document mentions that the low-refraction-index layer can be formed from an inorganic particle (such as a hollow silica particle), a film-forming binder (such as a fluorine-containing polymer having a low refraction index), and a polysiloxane for imparting an antifouling property to the fluorine-containing polymer.

However, the film described in this document needs a plurality of layers, which impart such properties as anti-glareness, a hardcoat property, and an anti-reflective property independently. It is difficult for a film having a single layer to attain these properties.

On the other hand, Japanese Patent Application Laid-Open No. 86764/2007 (JP-2007-86764A; Claims, and Paragraph Nos. [0029], [0095], and [0107]) discloses an optical film comprising a transparent plastic film substrate and a cured layer, having a dry thickness of not less than 100 nm, formed on the substrate. In the optical film, the cured layer is formed by coating a curable composition containing a low-refraction-index fine particle having a refraction index of not larger than 1.50 (e.g., a hollow silica particle which may be surface-treated) and a binder resin, and the low-refraction-index fine particles accumulate or gather near a surface of the cured layer opposite the substrate. This document mentions that in the optical film, the low-refraction-index fine particles are localized near the surface of the cured layer to form an apparent low-refraction-index layer, which inhibits reflection and has anti-reflective effects. The document also mentions that an optical film in which a highly hard inorganic fine particle (e.g., a silica fine particle) is used as the low-refraction-index fine particle imparts abrasion resistance to the surface of the film. Moreover, the document states that a hardcoat layer having an anti-reflective property and abrasion resistance is included as functions of the cured layer, the hardcoat layer is formed from a curable composition, and the curable composition contains the above-mentioned low-refraction-index fine particle and a binder for imparting a hardcoat property to the layer, and if necessary a mat particle for imparting anti-glareness or internal scattering property to the layer and an inorganic fine particle for imparting a high refraction index and a high strength to the layer and inhibiting a crosslinking contraction of the layer.

The film described in the document can achieve not only an anti-reflective property and a hardcoat property but also anti-glareness with the cured layer alone, which is a single layer, owing to the mat particle contained in the single layer. However, in order to provide the anti-glareness, it is necessary to protrude mat particle having a particle diameter of as large as about several micrometers from the surface of the cured layer. Therefore, since the localization of the hollow silica particles near the surface of the cured layer is insufficient, the film has an insufficient anti-reflective property. Moreover, cohesion between the mat particle and the hollow silica particle sometimes deteriorates the anti-reflective performance.

Further, Japanese Patent Application Laid-Open No. 53921/2000 (JP-2000-53921A, Claims) discloses a composition for forming an anti-reflective coat. The composition contains a compound which may provide a low-refraction-index cured coat and a compound which may provide a high-refraction-index cured coat. In the composition, a surface free energy of a coat formed by curing the compound which may provide the low-refraction-index cured coat is smaller than that of a coat formed by curing the compound which may provide the high-refraction-index cured coat. In this document, preferential deposition of a compound having a lower surface free energy on the surface of the coat is utilized in the case of a mixture containing a plurality of compounds. The low-refraction-index compound is deposited on the surface of the coat by reducing a surface free energy thereof, whereby a double layer, that is, a low-refraction-index layer and a high-refraction-index layer can be formed on the substrate in this order with respect to the air interface by a single coating step. The composition described in this document can impart an anti-reflective function to the substrate, but not anti-glareness.

### SUMMARY OF THE INVENTION

It is therefore an object of the present invention to provide a functional film having a single coated layer having a hardcoat property, an anti-reflective property, and anti-glareness, a process for producing the functional film, and a display apparatus provided with the functional film (e.g., a liquid crystal display apparatus).

An other object of the present invention is to provide a process for producing a functional film having a hardcoat property, an anti-reflective property, and anti-glareness by a simple and low-cost process, that is, a single-coating on a substrate film.

It is still another object of the present invention to provide a liquid coating composition useful for obtaining a functional film having a hardcoat property, an anti-reflective property, and anti-glareness.

The inventors of the present invention made intensive studies to achieve the above objects and finally found that a simple process which comprises applying (and curing) of a liquid coating composition (or a coating liquid) containing a plurality of resins capable of phase-separating from each other, a curable resin, and a hollow silica particle to a substrate (particularly, a transparent substrate) in a single coating step produces an uneven structure on a surface of the substrate due to a self-ordering phenomenon of a polymer (cellular rotating convection phenomenon and phase-separation phenomenon) and accumulates the hollow silica particles efficiently near the surface (or along the uneven structure of the surface), whereby a functional layer having three properties unrelated with each other (a hardcoat property, an anti-reflective property, and anti-glareness) which have been difficult to achieve or attain together can be formed on the substrate; and that a functional film obtained by such a process can inhibit reflection and make a black image (an image having a high light-room contrast) on a display even under an exterior light, whereby the functional film is extremely useful as a film of a liquid crystal display apparatus or the like. The present invention was accomplished based on the above findings.

That is, the functional film of the present invention comprises a substrate film (or a support) and a functional layer formed on the substrate film. The functional layer has a first side and a second side which is adjacent to the substrate film. In the functional film, the functional layer is a cured layer of a coated layer containing a resin binder comprising a plurality of resins capable of phase-separating from each other, a curable resin (or curable resins), and a hollow silica particle. In the functional film, the hollow silica particles accumulate or gather near the first side of the functional layer (or the hollow silica particles are localized near the first side of the functional layer).

The plurality of resins may contain at least a cellulose derivative. Moreover, at least one polymer of the plurality of resins may have a functional group reactive to the curable resin. Representatively, the plurality of resins may comprise a cellulose ester and a resin having a functional group reactive to the curable resin at a side chain thereof and being at least one resin selected from the group consisting of a (meth)acrylic resin, an alicyclic olefinic resin, and a polyester-series resin.

The hollow silica particles may have a mean particle diameter of 50 to 70 nm and a refraction index of 1.20 to 1.25.

The first side of the functional layer may usually have an uneven surface structure. Moreover, the hollow silica particles may accumulate or gather along the uneven surface structure. The uneven structure may be formed by at least phase separation of the plurality of resins, particularly formed by phase separation and convection phenomenon of the plurality of resins.

The surface of the functional layer may have a structure in which the hollow silica particles form most or all surface thereof. For example, the hollow silica particles may be present in not less than 90% of a surface area of the first side of the functional layer.

The present invention includes a process for producing a functional film. The process comprises a coating step for coating a substrate film with a liquid coating composition containing a resin binder comprising a plurality of resins capable of phase-separating from each other, a curable resin, and a hollow silica particle, a drying step for drying the resulting coated layer, and a curing step for curing the dried coated layer.

In the process, the liquid coating composition may contain at least two kinds of solvents with different boiling points. In particular, the liquid coating composition may contain at least one solvent having a boiling point not lower than 100° C. and at least one solvent having a boiling point lower than 100° C.

In the curing step, the coated layer may be irradiated with at least one selected from the group consisting of an actinic ray and heat.

The present invention includes a liquid coating composition for obtaining the functional film, and the composition contains a resin binder comprising a plurality of resins capable of phase-separating from each other, a curable resin, and a hollow silica particle.

The present invention also includes a display apparatus provided with the above-mentioned functional film. The display apparatus may be, for example, selected from the group consisting of a liquid crystal display, a cathode ray tube display, a plasma display, and a touch panel-equipped input device. The liquid crystal display apparatus may further comprise a prism sheet containing a prism unit having an approximately isosceles triangular cross-section.

Further, the present invention includes an optical member comprising a polarizing plate and the above-mentioned functional film laminated (or formed) on at least one surface of the polarizing plate.

### BRIEF DESCRIPTION OF THE DRAWINGS

FIG. 1 is a schematic cross-sectional view of an optical member comprising a functional film in accordance with an embodiment of the present invention and a polarizing plate on which the functional film is formed.

FIG. 2 is a schematic cross-sectional view of a liquid crystal panel produced in Examples.

FIG. 3 is a schematic cross-sectional view of a liquid crystal display apparatus produced in Examples.

FIG. 4 is a perspective view of a prism sheet used in Examples.

FIG. 5 is a perspective view of a backlight source used in Examples.

FIG. 6 is a laser reflection microphotograph of a functional film obtained in Example 1.

FIG. 7 is a scanning electron microphotograph (SEM) of a functional film obtained in Example 1.

FIG. 8 is an expanded photograph of part of FIG. 7.

FIG. 9 is a transmission electron microphotograph (TEM) of a cross section near a surface of a functional film obtained in Example 1.

### DETAILED DESCRIPTION OF THE INVENTION

### Functional Film

The functional film of the present invention at least comprises a functional layer (anti-glare layer or film) formed from specific components. The functional film may usually comprise a substrate (a substrate film or sheet, or a support film or sheet) and a functional layer formed on the substrate.

[Substrate]

A support having light transmittance properties, for example, a transparent support such as a synthetic resin film may usually be employed as the substrate (substrate film). Such a support having light transmittance properties may comprise a transparent polymer film for forming an optical member.

The transparent support (substrate sheet) may include, for example, a resin sheet (a resin film) in addition to a glass (substrate) and a ceramic (substrate). The same resins the same as those constituting an anti-glare layer as described later may be used as a resin constituting the transparent support.

The preferred transparent support includes a transparent polymer film, for example, a film formed from a cellulose derivative [e.g., a cellulose acetate such as a cellulose triacetate (TAC) or a cellulose diacetate], a polyester-series resin [e.g., a poly(ethylene terephthalate) (PET), a poly(butylene terephthalate) (PBT), and a polyarylate-series resin], a polysulfone-series resin [e.g., a polysulfone and a polyethersulfone (PES)], a polyetherketone-series resin [e.g., a polyetherketone (PEK) and a polyetheretherketone (PEEK)], a polycarbonate-series resin (PC), a polyolefinic resin (e.g., a polyethylene and a polypropylene), a cyclic polyolefinic resin (e.g., the trade name “ARTON”, the trade name “ZEONEX”, and the trade name “TOPAS”), a halogen-containing resin (e.g., a poly(vinylidene chloride)), a (meth)acrylic resin, a styrenic resin (e.g., a polystyrene), a vinyl acetate- or vinyl alcohol-series resin(e.g., a poly(vinyl alcohol)), or others. The transparent support may be stretched monoaxially or biaxially, and the transparent support having optical isotropy is preferred. The preferred transparent support is a support sheet or film having a low birefringence index. The optically isotropic transparent support may include a non-stretched sheet or film, for example, a sheet or film formed from a polyester (e.g., a PET and a PBT), a cellulose ester, in particular a cellulose acetate (e.g., a cellulose acetate such as a cellulose diacetate or a cellulose triacetate, a cellulose acetate C₃₋₄ acylate such as a cellulose acetate propionate or a cellulose acetate butyrate) or the like. The thickness of the support (e.g., the resin film) having a two-dimensional structure may be selected within the range of, for example, about 5 to 2000 μm, preferably about 15 to 1000 μm, and more preferably about 20 to 500 μm.

[Functional Layer]

The functional layer constituting the functional film of the present invention comprises (or is formed from) a hollow silica particle and a resin binder containing a plurality of resins (resin components) capable of phase-separating from each other. The functional layer is usually a cured layer formed by curing a coated layer containing a curable resin in addition to these components (the resin binder and the hollow silica particle). Incidentally, the curable resin can improve a hardcoat property (abrasion resistance) of the functional layer or impart the property to the functional layer. As described later, in the functional layer the hollow silica particles accumulate or gather near a surface (usually, a surface which is not adjacent to the substrate film). That is, the concentration of the hollow silica particles is disproportionately high near the surface.

(Resin Binder)

The resin binder is not particularly limited to a specific one as long as a plurality of resins capable of phase-separating from each other (or incompatible with each other) are contained in the resin binder. The resins are sometimes referred to as resin components, polymer components, or polymers. Incidentally, the resins which phase-separate from each other at or around a processing temperature may be used in combination.

The resin component (polymer component) may usually be a thermoplastic resin. The thermoplastic resin may include, for example, a styrenic resin, a (meth)acrylic resin, an organic acid vinyl ester-series resin, a vinyl ether-series resin, a halogen-containing resin, an olefinic resin (including an alicyclic olefinic resin), a polycarbonate-series resin, a polyester-series resin, a polyamide-series resin, a thermoplastic polyurethane resin, a polysulfone-series resin (e.g., a polyethersulfone and a polysulfone), a poly(phenylene ether)-series resin (e.g., a polymer of 2,6-xylenol), a cellulose derivative (e.g., a cellulose ester, a cellulose carbamate, and a cellulose ether), a silicone resin (e.g., a polydimethylsiloxane and a polymethylphenylsiloxane), a rubber or elastomer (e.g., a diene-series rubber such as a polybutadiene or a polyisoprene, a styrene-butadiene copolymer, an acrylonitrile-butadiene copolymer, an acrylic rubber, a urethane rubber, and a silicone rubber), and the like. These thermoplastic resins may be used singly or in combination.

The styrenic resin may include a homo- or copolymer of a styrenic monomer (e.g. a polystyrene, a styrene-α-methylstyrene copolymer, and a styrene-vinyl toluene copolymer), and a copolymer of a styrenic monomer and other polymerizable monomers [e.g., a (meth)acrylic monomer, maleic anhydride, a maleimide-series monomer, and a diene]. The styrenic copolymer may include, for example, a styrene-acrylonitrile copolymer (AS resin), a copolymer of styrene and a (meth)acrylic monomer [e.g., a styrene-methyl methacrylate copolymer, a styrene-methyl methacrylate-(meth)acrylate copolymer, and a styrene-methyl methacrylate-(meth)acrylic acid copolymer], and a styrene-maleic anhydride copolymer. The preferred styrenic resin includes a polystyrene, a copolymer of styrene and a (meth)acrylic monomer [e.g., a copolymer comprising styrene and methyl methacrylate as main units, such as a styrene-methyl methacrylate copolymer], an AS resin, a styrene-butadiene copolymer, and the like.

The (meth)acrylic resin to be used may include a homo- or copolymer of a (meth) acrylic monomer and a copolymer of a (meth)acrylic monomer and a copolymerizable monomer. The (meth)acrylic monomer may include, for example, (meth)acrylic acid; a C₁₋₁₀alkyl (meth)acrylate such as methyl (meth)acrylate, ethyl (meth)acrylate, butyl (meth)acrylate, t-butyl (meth)acrylate, isobutyl (meth)acrylate, hexyl (meth)acrylate, octyl (meth)acrylate, or 2-ethylhexyl (meth)acrylate; an aryl (meth)acrylate such as phenyl (meth)acrylate; a hydroxyalkyl (meth)acrylate such as hydroxyethyl (meth)acrylate or hydroxypropyl (meth)acrylate; glycidyl (meth)acrylate; an N,N-dialkylaminoalkyl (meth)acrylate; (meth)acrylonitrile; and a (meth)acrylate having an alicyclic hydrocarbon group such as tricyclodecane. The copolymerizable monomer may include the above styrenic monomer, a vinyl ester-series monomer, maleic anhydride, maleic acid, and fumaric acid. These monomers may be used singly or in combination.

The (meth)acrylic resin may include, for example, a poly(meth)acrylate such as a poly(methyl methacrylate), a methyl methacrylate-(meth)acrylic acid copolymer, a methyl methacrylate-(meth)acrylate copolymer, a methyl methacrylate-acrylate-(meth)acrylic acid copolymer, and a (meth)acrylate-styrene copolymer (MS resin). The preferred (meth)acrylic resin includes a poly(C₁₋₆alkyl (meth)acrylate) such as a poly (methyl (meth)acrylate). In particular, a methyl methacrylate-series resin containing methyl methacrylate as a main component (about 50 to 100% by weight, and preferably about 70 to 100% by weight) is preferred.

The organic acid vinyl ester-series resin may include a homo- or copolymer of a vinyl ester-series monomer (e.g., a poly(vinyl acetate) and a poly(vinyl propionate)), a copolymer of a vinyl ester-series monomer and a copolymerizable monomer (e.g., an ethylene-vinyl acetate copolymer, a vinyl acetate-vinyl chloride copolymer, and a vinyl acetate-(meth)acrylate copolymer), or a derivative thereof. The derivative of the vinyl ester-series resin may include a poly(vinyl alcohol), an ethylene-vinyl alcohol copolymer, a poly(vinyl acetal) resin, and the like.

The vinyl ether-series resin may include a homo- or copolymer of a vinyl C₁₋₁₀alkyl ether such as vinyl methyl ether, vinyl ethyl ether, vinyl propyl ether, or vinyl t-butyl ether, and a copolymer of a vinyl C₁₋₁₀alkyl ether and a copolymerizable monomer (e.g., a vinyl alkyl ether-maleic anhydride copolymer).

The halogen-containing resin may include a poly(vinyl chloride), a poly(vinylidene fluoride), a vinyl chloride-vinyl acetate copolymer, a vinyl chloride-(meth)acrylate copolymer, a vinylidene chloride-(meth)acrylate copolymer, and the like.

The olefinic resin may include, for example, an olefinic homopolymer such as a polyethylene or a polypropylene, and a copolymer such as an ethylene-vinyl acetate copolymer, an ethylene-vinyl alcohol copolymer, an ethylene-(meth)acrylic acid copolymer, or an ethylene-(meth)acrylate copolymer. Examples of the alicyclic olefinic resin may include a homo- or copolymer of a cyclic olefin such as norbornene or dicyclopentadiene (e.g., a polymer having an alicyclic hydrocarbon group such as tricyclodecane which is sterically rigid), a copolymer of the cyclic olefin and a copolymerizable monomer (e.g., an ethylene-norbornene copolymer and a propylene-norbornene copolymer). The alicyclic olefinic resin is available as, for example, the trade name “ARTON”, the trade name “ZEONEX”, the trade name “TOPAS”, and the like.

The polycarbonate-series resin may include an aromatic polycarbonate based on a bisphenol (e.g., bisphenol A), an aliphatic polycarbonate such as diethylene glycol bisallyl carbonate, and others.

The polyester-series resin may include an aromatic polyester obtain able from an aromatic dicarboxylic acid such as terephthalic acid [for example, a homopolyester, e.g., a poly(C₂₋₄ alkylene terephthalate) such as a poly(ethylene terephthalate) or a poly(butylene terephthalate), a poly(C₂₋₄ alkylene naphthalate), and a copolyester comprising a C₂₋₄ alkylene arylate unit (a C₂₋₄ alkylene terephthalate unit and/or a C₂₋₄ alkylene naphthalate unit) as a main component (e.g., not less than 50% by weight)]. The copolyester may include a copolyester in which one or some of C₂₋₄ alkylene glycols constituting a poly(C₂₋₄ alkylene arylate) is substituted with a poly(oxyC₂₋₄ alkylene glycol), a C₆₋₁₀alkylene glycol, an alicyclic diol (e.g., cyclohexane dimethanol and hydrogenated bisphenol A), a diol having an aromatic ring (e.g., 9,9-bis(4-(2-hydroxyethoxy)phenyl)fluorene having a fluorenone side chain, a bisphenol A, and a bisphenol A-alkylene oxide adduct) or the like, and a copolyester in which one or some of aromatic dicarboxylic acids as constituting units is substituted with an unsymmetric aromatic dicarboxylic acid such as phthalic acid or isophthalic acid, an aliphatic C₆₋₁₂ dicarboxylic acid such as adipic acid, or the like. The polyester-series resin may also include a polyarylate-series resin, an aliphatic polyester obtain able from an aliphatic dicarboxylic acid such as adipic acid, and a homo- or copolymer of a lactone such as ε-caprolactone. The preferred polyester-series resin is usually a non-crystalline resin, such as a non-crystalline copolyester (e.g., a C₂₋₄ alkylene arylate-series copolyester).

The polyamide-series resin may include a polyamide obtain able from a dicarboxylic acid (e.g., terephthalic acid, isophthalic acid, and adipic acid) and a diamine (e.g., hexamethylenediamine and metaxylylenediamine), a polyamide obtain able from a lactam such as ε-caprolactam, and others. The polyamide is not limited to a homopolyamide but may be a copolyamide. The representative polyamide-series resin includes, for example, an aliphatic polyamide such as a polyamide 46, a polyamide 6, a polyamide 66, a polyamide 610, a polyamide 612, a polyamide 11, or a polyamide 12.

Among the cellulose derivatives, the cellulose ester may include, for example, a fatty acid ester of a cellulose (e.g., a C₁₋₆ organic acid ester of a cellulose such as a cellulose acetate (e.g., a cellulose diacetate and a cellulose triacetate), a cellulose propionate, a cellulose butyrate, a cellulose acetate propionate, or a cellulose acetate butyrate), an aromatic carboxylic acid ester of a cellulose (e.g. a C₇₋₁₂ aromatic carboxylic acid ester of a cellulose such as a cellulose phthalate or a cellulose benzoate), an inorganic acid ester of a cellulose (e.g., a cellulose phosphate and a cellulose sulfate) and may be a mixed acid ester of a cellulose such as a cellulose acetate nitrate. The cellulose derivative may also include a cellulose carbamate (e.g. a cellulose phenylcarbamate), a cellulose ether (e.g., a cyanoethylcellulose; a hydroxyC₂₋₄alkyl cellulose such as a hydroxyethyl cellulose or a hydroxypropyl cellulose; a C₁₋₆alkyl cellulose such as a methyl cellulose or an ethyl cellulose; a carboxymethyl cellulose or a salt thereof, a benzyl cellulose, and an acetyl alkyl cellulose).

The preferred thermoplastic resin includes, for example, a styrenic resin, a (meth)acrylic resin, a vinyl acetate-series resin, a vinyl ether-series resin, a halogen-containing resin, an alicyclic olefinic resin, a polycarbonate-series resin, a polyester-series resin, a polyamide-series resin, a cellulose derivative, a silicone-series resin, and a rubber or elastomer, and the like. The thermoplastic resin to be usually employed includes a resin that is non-crystalline and is soluble in an organic solvent (particularly a common solvent for dissolving a plurality of polymers and curable compounds). In particular, a resin that has an excellent moldability or film-forming (film-formable) properties, transparency, and weather resistance [for example, a styrenic resin, a (meth)acrylic resin, an alicyclic olefinic resin, a polyester-series resin, and a cellulose derivative (e.g., a cellulose ester)] is preferred. In particular, in the present invention, it is preferable that at least the cellulose derivative be used as the thermoplastic resin. Since the cellulose derivative is a semisynthetic polymer and is different in dissolution behavior from other resins or curable resins, the cellulose derivative has a very good phase separability.

A polymer having a functional group participating (or being involved) in a curing reaction (or a functional group capable of reacting with the curable precursor) may be used as the above-mentioned polymer (or thermoplastic resin). Such a polymer may have the functional group in a main chain thereof or in a side chain thereof. The functional group may be introduced into a main chain of the polymer with co-polymerization, co-condensation or the like and is usually introduced into a side chain of the polymer. Such a functional group may include a condensable or reactive functional group (for example, a hydroxyl group, an acid anhydride group, a carboxyl group, an amino or an imino group, an epoxy group, a glycidyl group, and an isocyanate group), a polymerizable functional group [for example, a C₂₋₆ alkenyl group such as vinyl, propenyl, isopropenyl, butenyl, or allyl, a C₂₋₆ alkynyl group such as ethynyl, propynyl, or butynyl, a C₂₋₆ alkenylidene group such as vinylidene, or a functional group having the polymerizable functional group(s) (e.g., (meth)acryloyl group)], and others. Among these functional groups, the polymerizable functional group is preferred.

The thermoplastic resin having a polymerizable group in a side chain thereof, for example, may be produced by allowing (i) a thermoplastic resin having a reactive group (e.g., a group similar to the functional group exemplified in the paragraph of the condensable or reactive functional group) to react with (ii) a compound (polymerizable compound) having a group (reactive group) reactive to the reactive group of the thermoplastic resin and a polymerizable functional group to introduce the polymerizable functional group of the compound (II) into the thermoplastic resin.

Examples of the thermoplastic resin (i) having the reactive group may include a thermoplastic resin having a carboxyl group or an acid anhydride group thereof [for example, a (meth)acrylic resin (e.g., a (meth)acrylic acid-(meth)acrylate copolymer such as a methyl methacrylate-(meth)acrylic acid copolymer, and a methyl methacrylate-acrylate-(meth)acrylic acid copolymer), a polyester-series resin or polyamide-series resin having a terminal carboxyl group], a thermoplastic resin having a hydroxyl group [for example, a (meth)acrylic resin (e.g., a (meth)acrylate-hydroxyalkyl (meth)acrylate copolymer), a polyester-series resin or a polyurethane-series resin having a terminal hydroxyl group, a cellulose derivative (e.g., a hydroxyC₂₋₄alkyl cellulose such as a hydroxyethyl cellulose or a hydroxypropylcellulose), a polyamide-series resin (e.g., an N-methylolacrylamide copolymer)], a thermoplastic resin having an amino group (e.g., a polyamide-series resin having a terminal amino group), and a thermoplastic resin having an epoxy group [e.g., a (meth)acrylic resin or polyester-series resin having an epoxy group (such as a glycidyl group)]. Moreover, there may be used a resin obtained by introducing the reactive group into a thermoplastic resin (such as a styrenic resin or an olefinic resin, and an alicyclic olefinic resin) with co-polymerization or graft polymerization as the thermoplastic resin (i) having the reactive group. Among these thermoplastic resins (i), a thermoplastic resin having a carboxyl group or an acid anhydride group thereof, a hydroxyl group or a glycidyl group (particularly a carboxyl group or an acid anhydride group thereof) as a reactive group, is preferred. Incidentally, among the (meth)acrylic resins, the copolymer preferably contains (meth)acrylic acid in a proportion of not less than 50 mol %. These thermoplastic resins (i) may be used singly or in combination.

The reactive group of the polymerizable compound (II) may include a group reactive to the reactive group of the thermoplastic resin (i), for example, a functional group similar to the condensable or reactive functional group exemplified in the paragraph of the functional group of the polymer mentioned above.

Examples of the polymerizable compound (II) may include a polymerizable compound having an epoxy group [e.g. an epoxy group-containing (meth)acrylate (an epoxyC₃₋₈alkyl (meth)acrylate such as glycidyl (meth)acrylate or 1,2-epoxybutyl (meth)acrylate; an epoxycycloC₅₋₈ alkenyl (meth)acrylate such as epoxycyclohexenyl (meth)acrylate), and allyl glycidyl ether], a compound having a hydroxyl group [for example, a hydroxyl group-containing (meth)acrylate, e.g., a hydroxyC₂₋₄alkyl (meth)acrylate such as hydroxypropyl (meth)acrylate; a C₂₋₆ alkylene glycol mono(meth)acrylate such as ethylene glycol mono(meth)acrylate], a polymerizable compound having an amino group [e.g., an amino group-containing (meth)acrylate; a C₃₋₆ alkenylamine such as allylamine; an aminostyrene such as 4-aminostyrene or diaminostyrene], a polymerizable compound having an isocyanate group [e.g., a (poly)urethane (meth)acrylate, or vinylisocyanate], and a polymerizable compound having a carboxyl group or an acid anhydride group thereof [e.g., an unsaturated carboxylic acid or an anhydride thereof, such as (meth)acrylic acid or maleic anhydride]. These polymerizable compounds (ii) may be used singly or in combination.

Incidentally, the combination of the reactive group of the thermoplastic resin (i) with the reactive group of the polymerizable compound (ii) may include, for example, the following combinations.

(i-1) the reactive group of the thermoplastic resin (i): carboxyl group or acid anhydride group thereof,

the reactive group of the polymerizable compound (ii): epoxy group, hydroxyl group, amino group, isocyanate group;

(i-2) the reactive group of the thermoplastic resin (i): hydroxyl group,

the reactive group of the polymerizable compound (ii): carboxyl group or acid anhydride group thereof, isocyanate group;

(i-3) the reactive group of the thermoplastic resin (i): amino group,

the reactive group of the polymerizable compound (ii): carboxyl group or acid anhydride group thereof, epoxy group, isocyanate group; and

(i-4) the reactive group of the thermoplastic resin (i): epoxy group,

the reactive group of the polymerizable compound (ii): carboxyl group or acid anhydride group thereof, amino group

Among the polymerizable compounds (ii), an epoxy group-containing polymerizable compound (such as an epoxy group-containing (meth)acrylate) is particularly preferred.

The functional group-containing polymer, e.g., a polymer in which a polymerizable unsaturated group is introduced into one or some of carboxyl groups in a (meth)acrylic resin, is available, for example, as “CYCLOMER-P” from Daicel Chemical Industries, Ltd. Incidentally, “CYCLOMER-P” is a (meth)acrylic polymer in which epoxy group(s) of 3,4-epoxycyclohexenylmethyl acrylate is allowed to react with one or some of carboxyl groups in a (meth)acrylic acid-(meth)acrylate copolymer for introducing photo-polymerizable unsaturated group(s) into the side chain of the polymer.

The amount of the functional group (particularly the polymerizable group) that participates in (or being involved in) a curing reaction and is introduced into the thermoplastic resin, is about 0.001 to 10 mol, preferably about 0.01 to 5 mol and more preferably about 0.02 to 3 mol relative to 1 kg of the thermoplastic resin.

The glass transition temperature of the thermoplastic resin (polymer) may be selected within the range of, for example, about −100° C. to 250° C., preferably about −50° C. to 230° C., and more preferably about 0° C. to 200° C. (for example, about 50° C. to 180° C.).

Considering the surface hardness, it is advantageous that the glass transition temperature of the thermoplastic resin (polymer) is not lower than 50° C. (e.g., about 70° C. to 200° C.) and preferably not lower than 100° C. (e.g., about 100° C. to 170° C.). The weight-average molecular weight of the polymer may be selected from the range of, for example, not more than 1,000,000, and preferably about 1,000 to 500,000.

As described above, the resin binder comprises a plurality of resins capable of phase-separating from each other. The plurality of resin components (polymers) may be capable of phase-separating from each other (in the absence of a solvent), or may be capable of phase-separating in a liquid phase before completion of evaporation of a solvent. Moreover, the plurality of polymers may be incompatible with each other.

Incidentally, the resin binder may further contain a resin component which is not phase-separable from at least one of the plurality of resin components (thermoplastic resins). For example, the resin binder may comprise two resin components capable of phase-separating from each other and a resin component which is not phase-separable from (or which is compatible with) any one of these components.

The combination of the resin components capable of phase-separating from each other is not particularly limited to a specific one as long as the combined resin components are phase-separable from each other. A plurality of polymers incompatible with each other in the neighborhood of a processing temperature, for example, two polymers incompatible with each other may be used in a suitable combination. The difference in refraction index between the plurality of polymers (a first polymer and a second polymer) may be about 0 to 0.06, for example, about 0 to 0.04 (e.g., about 0.0001 to 0.04), and preferably about 0.001 to 0.03. Too large difference in refraction index between these polymers causes a large difference in refraction index between phase-separated domains formed within the functional layer. As a result, the functional layer easily generates an internal haze, and the advantages of the present invention are reduced.

The plurality of resins (or the resin binder) may comprise at least a cellulose derivative, particularly, a cellulose ester (for example, a cellulose C₂₋₄ aliphatic carboxylic acid ester such as a cellulose diacetate, a cellulose triacetate, a cellulose acetate propionate, or a cellulose acetate butyrate). For example, when the first polymer is a cellulose derivative (e.g., a cellulose ester such as a cellulose acetate propionate), the second polymer is preferably a (meth)acrylic resin, an alicyclic olefinic resin (e.g., a polymer obtained by using norbornene as a monomer), or a polyester-series resin (e.g., the above-mentioned polyC₂₋₄ alkylene arylate-series copolyester). In particular, among these resins, the preferred resin includes a polymer having neither of aromatic ring nor halogen atom.

Moreover, in order to improve abrasion resistance after curing, it is preferable that at least one polymer (e.g., one of polymers incompatible with each other) in the plurality of resin components contained in the resin binder have a functional group (particularly, in a side chain thereof) that is reactive to the curable resin.

The ratio (weight ratio) of the first polymer relative to the second polymer [the former/the latter] may be selected from the range of, for example, about 1/99 to 99/1, preferably about 5/95 to 95/5 and more preferably about 10/90 to 90/10, and is usually about 20/80 to 80/20, particularly about 30/70 to 70/30. In particular, in the use of a cellulose derivative as the first polymer, the ratio (weight ratio) of the first polymer relative to the second polymer [the former/the latter] may be, for example, about 1/99 to 30/70, preferably about 5/95 to 28/72, and more preferably about 10/90 to 27/73 (particularly, about 15/85 to 25/75).

In particular, in the resin binder containing the cellulose derivative, the proportion of cellulose derivative relative to the whole resin binder may be, for example, about 0.5 to 30% by weight, preferably about 1 to 25% by weight, more preferably about 2 to 20% by weight (e.g., about 3 to 15% by weight), and particularly about 4 to 12% by weight.

(Curable Resin)

As mentioned above, in order to impart abrasion resistance (hardcoat property) to the functional layer or improve the abrasion resistance (hardcoat property) of the functional layer, the functional layer is usually a cured layer obtained by curing a coated layer further containing a curable resin (or curable resins). Specifically, the functional layer comprises a cured resin obtained by eventual curing with an actinic ray (e.g., an ultra violet ray, and an electron beam), heat, or means. Accordingly, such a cured resin can impart the abrasion resistance (hardcoat property) to the functional film and can improve durability of the functional film. Moreover, the cured layer formed from the coated layer containing the cured resin can immobilize (or stabilize) an uneven surface shape (or structure) of the functional layer.

The curable resin (or curable resin precursor) to be used may include various curable compounds having a reactive functional group to heat or an actinic ray (e.g., an ultra violet ray, and an electron beam) and being capable of forming a resin (particularly a cured or a crosslinked resin) by curing or crosslinking with heat or an actinic ray.

The curable resin (or precursor) may include, for example, a thermosetting compound or resin [a low molecular weight compound (or prepolymer such as a low molecular weight resin (e.g., an epoxy-series resin, an unsaturated polyester-series resin, a urethane-series resin, and a silicone-series resin)) having an epoxy group, an isocyanate group, an alkoxysilyl group, a silanol group, a polymerizable group (such as vinyl group, allyl group, or (meth)acryloyl group), or others], and a photo-curable compound that is curable with an actinic ray (such as ultra violet ray) (e.g., an ultra violet-curable compound such as a photo-curable monomer, oligomer, or prepolymer). The photo-curable compound may be an EB (electron beam)-curable compound, or others. Incidentally, a photo-curable compound such as a photo-curable monomer, a photo-curable oligomer, or a photo-curable resin which may have a low molecular weight is sometimes simply referred to as “photo-curable resin”. These curable resin precursors may be used singly or in combination.

The photo-curable compound usually has a photo-curable group, for example, a polymerizable group (e.g., vinyl group, allyl group, (meth)acryloyl group) or a photosensitive group (e.g., cinnamoyl group). In particular, the preferred compound includes a photo-curable compound having a polymerizable group [e.g., a monomer, an oligomer (or resin, particularly a low molecular weight resin)]. These photo-curable compounds may be used singly or in combination.

Among the photo-curable compounds having a polymerizable group, the monomer may include, for example, a monofunctional monomer [for example, a (meth)acrylic monomer such as a (meth)acrylic ester, e.g., an alkyl (meth)acrylate (e.g., a C₁₋₂₄alkyl (meth)acrylate such as methyl (meth)acrylate, ethyl (meth)acrylate, butyl (meth)acrylate, isobutyl (meth)acrylate, 2-ethylhexyl (meth)acrylate, isodecyl (meth)acrylate, n-lauryl (meth)acrylate, or n-stearyl (meth)acrylate), a cycloalkyl (meth)acrylate, a (meth)acrylate having a crosslinked cyclic hydrocarbon group (e.g., isobornyl (meth)acrylate and adamantyl (meth)acrylate), glycidyl (meth)acrylate, a fluorine-containing alkyl (meth)acrylate such as perfluorooctylethyl (meth)acrylate or trifluoroethyl (meth)acrylate; a vinyl-series monomer such as a vinyl ester (e.g., vinyl acetate) or vinylpyrrolidone], a polyfunctional monomer having at least two polymerizable unsaturated bonds [for example, an alkylene glycol di(meth)acrylate such as ethylene glycol di(meth)acrylate, propylene glycol di(meth)acrylate, butanediol di(meth)acrylate, neopentyl glycol di(meth)acrylate, or hexanediol di(meth)acrylate; a (poly)alkylene glycol di(meth)acrylate such as diethylene glycol di(meth)acrylate, dipropylene glycol di(meth)acrylate, or a polyoxytetramethylene glycol di(meth)acrylate; a di(meth)acrylate having a crosslinked cyclic hydrocarbon group (e.g., tricyclodecane dimethanol di(meth acrylate and adamantane di(meth)acrylate); and a polyfunctional monomer having about 3 to 6 polymerizable unsaturated bonds (e.g., trimethylolpropane tri(meth)acrylate, trimethylolethane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate)].

Among the photo-curable compounds having a polymerizable group, examples of the oligomer or resin may include a (meth)acrylate of a bisphenol A added with an alkylene oxide, an epoxy (meth)acrylate (e.g., a bisphenol A-based epoxy (meth)acrylate, and a novolak-based epoxy (meth)acrylate), a polyester (meth)acrylate (e.g., an aliphatic polyester-based (meth)acrylate and an aromatic polyester-based (meth)acrylate), a (poly)urethane (meth)acrylate (e.g., a polyester-based urethane (meth)acrylate and a polyether-based urethane (meth)acrylate), a silicone (meth)acrylate, and others. A hybrid photo-curable compound manufactured by JSR Corporation has been put on the market under the trade name “OPSTAR”.

The preferred curable resin precursor includes a photo-curable compound curable in a short time, for example, an ultra violet-curable compound (e.g., a monomer, an oligomer, and a resin which may have a low molecular weight) and an EB-curable compound. In particular, a resin precursor having a practical advantage is an ultra violet-curable monomer or an ultra violet-curable resin. Further, in order to improve resistance such as abrasion resistance, the photo-curable resin is preferably a compound having not less than 2 (preferably about 2 to 6, and more preferably about 2 to 4) polymerizable unsaturated bonds in the molecule.

The molecular weight of the curable resin is, allowing for compatibility to the polymer, not more than about 5000 (e.g., about 100 to 5000), preferably not more than about 2000 (e.g., about 150 to 2000), and more preferably not more than about 1000 (e.g., about 200 to 1000).

The curable resin may be used in combination with a curing agent depending on the variety of the resin. For example, a thermosetting resin may be used in combination with a curing agent such as an amine or a polyfunctional carboxylic acid (or a polycarboxylic acid), or a photo-curable resin may be used in combination with a photopolymerization initiator.

The photopolymerization initiator may include a conventional component, e.g., an acetophenone, a propiophenone, a benzyl, a benzoin, a benzophenone, a thioxanthone, an acylphosphine oxide, and others.

The content of the curing agent (such as a photo-curing agent) relative to 100 parts by weight of the curable resin is about 0.1 to 20 parts by weight, preferably about 0.5 to 10 parts by weight, and more preferably about 1 to 8 parts by weight (particularly about 1 to 5 parts by weight) and may be about 3 to 8 parts by weight.

Further, the curable resin precursor may contain a curing accelerator, a crosslinking agent, a thermal-polymerization inhibitor, and others. For example, the photo-curable resin precursor may be used in combination with a photo-curing accelerator, e.g., a tertiary amine (e.g., a dialkylaminobenzoic ester) or a phosphine-series photopolymerization accelerator.

In the present invention, the resin binder comprises a plurality of resin components capable of phase-separating from each other, as described above. The resin binder may have or may not have phase-separability from (or incompatibility with) the curable resin (particularly, a monomer or oligomer having a plurality of curable functional groups). Moreover, a curable resin precursor which is compatible with at least one of the polymers (resin components) around a processing temperature is practically used. For example, in a combination use of the curable resin and the plurality of polymers incompatible with each other containing a first polymer and a second polymer, the curable resin is not particularly limited to a specific one as long as the curable resin is compatible with at least one of the first and second polymers. The curable resin may be compatible with both polymers. A resin binder containing a curable resin compatible with both polymer components phase-separates into two phases, where one is a phase of a mixture containing the first polymer and the curable resin as main components, and another is a phase of a mixture containing the second polymer and the curable resin as main components.

When both components to be phase-separated are highly compatible with each other, both components fail to generate phase separation effectively during a drying step for evaporating the solvent, and the obtained layer has lower functions for an anti-glare layer.

Incidentally, each of the phase separability of the plurality of polymers and the phase separability of the polymer and the curable monomer can be judged conveniently by preparing a uniform solution with a good solvent to both components and visually conforming whether the residual solid content becomes clouded or not during a step for evaporating the solvent gradually.

Further, the plurality of polymers and a cured or crosslinked resin obtained by curing the curable resin are usually different from each other in refraction index. Moreover, the plurality of polymers (for example, a first polymer and a second polymer) are also different from each other in refraction index. In the present invention, the difference in refraction index between the polymer and the cured or crosslinked resin, or the difference in refraction index between the plurality of polymers (the first polymer and the second polymer) may be, for example, about 0 to 0.06, preferably about 0.0001 to 0.05, and more preferably about 0.001 to 0.04. The selection of the polymers having such a difference in refraction index can produce phase-separated domains having such a difference in refraction index.

The proportion (weight ratio) of the resin binder (or the plurality of resins) relative to the curable resin is not particularly limited to a specific one, and for example, the resin binder/the curable resin may be selected within the range of about 5/95 to 95/5. In order to enhance the surface hardness, the proportion (weight ratio) is preferably about 5/95 to 80/20, more preferably about 10/90 to 70/30, and particularly about 15/85 to 60/40. In particular, in the resin binder containing the cellulose derivative in whole or in part, the proportion (weight ratio) of the resin binder (or the plurality of resins) relative to the curable resin may be about 10/90 to 80/20, preferably about 20/80 to 70/30, and more preferably about 30/70 to 60/40 (e.g., about 35/65 to 55/45).

(Hollow Silica Particle)

As described above, the functional layer (or coated layer) contains a hollow silica particle. Incidentally, in this description, the hollow silica particle means a silica particle having a cavity therein.

The shape of the whole hollow silica particle is not particularly limited to a specific one. For example, the shape may include a spherical shape, an ellipsoidal shape, and an amorphous shape. Among these shapes, the hollow silica particle may usually have a spherical shape.

The shape and size of the cavity in the hollow silica particle are not particularly limited to specific ones as far as the refraction index of the particle is within the after-mentioned range.

The hollow silica particle may usually comprise one cavity as a core and an outer shell (or a shell) thereof. In the case of a spherical particle, the particle may have one spherical cavity. The hollow silica particle may have a plurality of cavities (e.g., cavities having a spherical shape or an ellipsoidal shape) therein. Such a hollow silica particle is described in Japanese Patent Application Laid-Open Nos. 233611/2001 (JP-2001-233611A), 192994/2003 (JP-2003-192994A), and others. The hollow silica particles as described in these documents are a colloidal particle having a low refraction index, and have an excellent dispersibility. In the present invention, the hollow silica particles as described in these documents may be preferably used, and the particles may be produced by production processes as described in these documents.

The mean particle diameter of the hollow silica particles may be selected from the range of not less than 100 nm (e.g., about 30 nm to 90 nm) and may be about 40 to 80 nm, preferably about 50 to 70 nm, and more preferably about 55 to 65 nm. Hollow silica particles having an extremely small mean particle diameter increase a refraction index of the functional layer following an increase of the refraction index of the particles. Therefore, the functional film has a low light-room contrast, which tends to allow a screen image to be whitish. On the other hand, hollow silica particles having an extremely large mean particle diameter act as a scatterer in itself and sometimes causes undesired light scattering. Therefore, also in this case, a screen image is liable to be whitish.

The refraction index (n) of the hollow silica particle may be, for example, about 1.2 to 1.25, and preferably about 1.21 to 1.24. Too a low refraction index of the particle deteriorates efficient production of the functional layer. Too a high refraction index of the particle makes that of the functional layer higher, and deteriorates light-room contrast. As a result, a screen image is liable to be whitish.

The hollow silica particle may usually be a surface-treated (or finished) particle [for example, a surface-treated hollow silica particle (a hollow silica particle surface-treated with a surface-treating (or finishing) agent]. The surface-treating agent may include, for example, a coupling agent such as a silane coupling agent.

Examples of the silane coupling agent may include an alkoxysilyl group-containing silane coupling agent [for example, a tetraalkoxysilane (e.g., a tetraC₁₋₄ alkoxysilane such as tetramethoxysilane or tetraethoxysilane, and tetraphenoxysilane) and a trialkoxysilane (e.g., a C₁₋₁₂ alkyltriC₁₋₄ alkoxysilane such as methyltrimethoxysilane or octyltriethoxysilane, a diC₂₋₄ alkyldiC₁₋₄ alkoxysilane such as dimethyldimethoxysilane, and an arylC₁₋₄ alkoxysilane such as phenyltrimethoxysilane or diphenyldimethoxysilane)], a halogen-containing silane coupling agent [e.g., a trifluoroC₂₋₄ alkyldiC₁₋₄ alkoxysilane such as trifluoropropyltrimethoxysilane, a perfluoroalkylC₂₋₄ alkyldiC₁₋₄ alkoxysilane such as perfluorooctylethyltrimethoxysilane, a chloroC₂₋₄alkyltriC₁₋₄ alkoxysilane such as 2-chloroethyltrimethoxysilane, and a C₁₋₄ alkyltrichlorosilane such as methyltrichlorosilane], a vinyl group-containing silane coupling agent (e.g., a vinyltriC₁₋₄ alkoxysilane such as vinyltrimethoxysilane), an ethylenic unsaturated bond group-containing silane coupling agent [e.g., a (meth)acryloxyC₂₋₄alkylC₁₋₄ alkoxysilane such as 2-(meth)acryloxyethyltrimethoxysilane or 3-(meth)acryloxypropylmethyldimethoxysilane], an epoxy group-containing silane coupling agent [e.g., a C₂₋₄ alkyltriC₁₋₄ alkoxysilane having an alicyclic epoxy group such as 2-(3,4-epoxycyclohexyl)ethyltrimethoxysilane, a glycidyloxyC₂₋₄ alkyltriC₁₋₄ alkoxysilane such as 2-glycidyloxyethyltrimethoxysilane, and 3-(2-glycidyloxyethoxy)propyltrimethoxysilane, an amino group-containing silane coupling agent [e.g., a aminoC₂₋₄alkylC₁₋₄ alkoxysilane such as 2-aminoethyltrimethoxysilane or 3-aminopropylmethyldimethoxysilane, 3-[N-(2-aminoethyl)amino]propyltrimethoxysilane, N-phenyl-3-aminopropyltrimethoxysilane, and 3-ureidoisopropylpropyltriethoxysilane], a mercapto group-containing silane coupling agent (e.g., a mercaptoC₂₋₄ alkyltriC₁₋₄ alkoxysilane such as 3-mercaptopropyltrimethoxysilane), a carboxyl group-containing silane coupling agent (e.g., a carboxyC₂₋₄ alkyl triC₁₋₄ alkoxysilane such as 2-carboxyethyltrimethoxysilane), and a silanol group-containing silane coupling agent (e.g., trimethylsilanol). These silane coupling agents may be used singly or in combination.

Conventional methods (e.g., methods as described in the above-mentioned JP-2001-233611A or JP-2003-192994A) may be utilized as a surface-treatment method. The utilizable method include a method that comprises adding a coupling agent such as a silane coupling agent to a dispersion of the hollow silica particle (e.g., an alcohol dispersion), and further adding water to the dispersion, and adding a hydrolysis catalyst such as an acid or an alkali thereto according to need.

Incidentally, such a hollow silica particle component is obtain able, for example, in the form of dispersion (or dispersion liquid). The dispersion is added to a liquid coating composition for imparting anti-glareness to the functional layer. Such a dispersion is available, for example, as “SH-1123SIV” manufactured by JGC Catalysts and Chemicals Ltd.

The proportion of the hollow silica particle may be, for example, about 0.1 to 20% by weight, preferably about 0.2 to 15% by weight, more preferably about 0.3 to 10% by weight, and particularly about 0.5 to 5% by weight, relative to the functional layer (the whole solid content of the functional layer). Moreover, in the functional layer, the proportion of the hollow silica particle may be, for example, about 0.5 to 30 parts by weight, preferably about 1 to 25 parts by weight, more preferably about 1.5 to 20 parts by weight, and particularly about 2 to 15 parts by weight, relative to 100 parts by weight of the resin binder.

(Structure of Functional Layer)

The functional layer comprises the resin binder and the hollow silica particle and is usually a cured layer formed by curing a coated layer containing the resin binder, the curable resin, and the hollow silica particle.

Such a functional layer usually has an uneven surface structure (uneven surface shape). The uneven surface structure is usually formed by phase separation of the plurality of resins (or resin binder). In particular, the uneven structure may be formed by at least phase separation and convection phenomenon (convection phenomenon in a surface of the coated layer) of the plurality of resins.

More specifically, the functional layer comprises a plurality of domains phase-separated from each other and a matrix, and has an uneven surface formed by the domains and the matrix. That is, with the progress of the phase separation, the bicontinuous phase structure is formed. In further proceeding the phase separation, owing to the difference in surface tension of the plurality of resins constituting the continuous phase, the continuous phase becomes discontinuous, and a droplet phase structure (e.g., an islands-in-the-sea structure containing independent phases such as ball-like shape, spherical shape, discotic shape, oval-sphere shape or rectangular (prism) shape) is formed. Therefore, an intermediate structure of the bicontinuous phase structure and the drop phase structure (i.e., a phase structure in the transition from the bicontinuous phase to the drop phase) can also be formed by varying the degree of phase separation. The phase-separation structure in the functional layer in the present invention may be an islands-in-the-sea structure (a droplet phase structure or a phase structure in which one phase is separated or isolated) or a bicontinuous phase structure (or a mesh structure), or may be an intermediate structure being a coexistent state of a bicontinuous phase structure and a droplet phase structure. Incidentally, the domains may be formed regularly or periodically. The phase-separation structure (domain) can be observed by an examination of the cross section of the film under a transmission electron microscope.

Thus a difference in refraction index between materials constituting the functional layer having an uneven surface (the plurality of polymers and the cured product of the curable resin) can be adjusted within the above-mentioned range. Accordingly, the functional layer substantially contains no scattering medium that causes scattering in the interior of the layer, unlike a functional layer obtained by a method that comprises dispersing a fine particle to form an uneven surface. Therefore, the haze in the interior of the layer (the internal haze causing scattering in the interior of the layer) is low, for example, may be about 0 to 3%, preferably about 0 to 2% (e.g., about 0.1 to 1.5%), and more preferably about 0 to 1% (e.g., 0.1 to 0.8%). Incidentally, the internal haze can be determined by pasting a smooth transparent film on the uneven surface of the functional layer through a transparent adhesive layer and measuring a haze of the planarized matter.

In the present invention, the plurality of domains of the surface of the functional layer are formed at a relatively controlled interval corresponding to arrangement of convection cells formed in a production process of the functional layer. In particular, the functional layer has an uneven surface formed due to convection cells. Such an uneven structure (domains) is a closed uneven (loop) region, and usually, it is sufficient that the loop (exterior loop) is almost closed. Moreover, almost all of the domains may be separated, or some adjacent domains may be connected with each other through a long and slender (or narrow) connection part. The shape of the domain is not particularly limited to a specific one, and is an amorphous shape, a circular form, an oval (or elliptical) form, a polygonal form, and others. The shape is usually a circular form or an oval form.

Further, usually the domain (uneven surface) formed by cellular rotating convection substantially has regularity or periodicity. The mean distance between two adjacent projections of such an uneven surface [the pitch between the tops of two adjacent projections (or between the domains)] may be selected from the range of about 50 to 200 μm. For example, the mean distance is, for example, about 100 to 150 μm, and preferably about 120 to 140 μm. The mean distance between two adjacent projections is, for example, controllable by the thickness of the coated layer when convection is generated.

Furthermore, in the functional layer, at least one uneven part (internal cell) may be formed within each domain in the surface. The shape of the surface of each domain may be, as observed from the viewpoint perpendicular to the plane direction of functional layer, for example, a double-circle form or a circular form in which a circle forming each domain has a plurality of small circles therein. That is, the uneven part formed in each domain may be formed as a raised (or upheaved) part (minute raised region) formed by a rising flow or a depressed part (minute depressed region) or caved by a rising flow at a position corresponding to a central region (or area) or peripheral region (or area) of the convection cell. This uneven part is also a closed loop (interior loop), and usually, the interior loop may be almost closed. Moreover, the interior loop is separated or isolated in many cases. Some adjacent loops may be connected with each other through a long and slender (or narrow) connection part. In particular, one to several (e.g., about 1 to 3) uneven part(s) (particularly punctiform raised part(s)) may be formed within one domain. The shape of the uneven part (interior loop) (the two-dimensional shape of the film surface, or the outline of the border between the interior loop and the exterior loop) is not particularly limited to a specific one and is amorphous, a circular form, an oval form, a polygonal form, and others. The shape is usually a circular form or an oval form. Incidentally, in the case where a minute uneven part is formed inside each convection cell by a rising flow or phase-separation structure, the light scattering property of the film is improved. As a result, dazzle of a reflection image can be inhibited. Further, such a formation of a minute uneven part inside each convection cell is particularly preferred since each distance between interior loops of the cells becomes more equal, so that the uneven shape of the domain is formed uniformly.

The size (diameter) of the interior loop (minute uneven part) may be, for example, about 3 to 150 μm, and is preferably about 5 to 100 μm and more preferably about 10 to 50 μm (particularly about 15 to 40 μm). The area ratio of the interior loop is about 1 to 80%, preferably about 3 to 50% and more preferably about 5 to 40% (particularly about 10 to 30%) relative to the exterior loop area.

(Low-Refraction-Index Layer)

In the functional film of the present invention, the hollow silica particles are present in the functional layer so that the particles are localized near a surface of the functional layer (at least one surface side of the functional layer, particularly a surface side of the functional layer opposite the substrate). The localization of the hollow silica particles can effectively inhibit an external light (e.g., an exterior light source) from reflecting on the surface of the functional film when the low-refraction-index layer is disposed so that the layer becomes the top layer in a display apparatus such as a liquid crystal display apparatus. That is, the functional layer (or cured layer) serves as an anti-glare layer (or an anti-glare hardcoat layer) having an anti-reflecting function since an anti-reflective property (and hardcoat property) is imparted to the functional layer.

The hollow silica particles may usually accumulate or gather (or are localized) along the uneven surface structure. The hollow silica particles may form a layer along the uneven structure of the surface. Specifically, the functional layer may have a layer of the hollow silica particles [a layer of (or formed by) the localized hollow silica particles (a low-refraction-index layer)] in a surface layer region containing the uneven surface structure formed by the phase separation of the resin binder. The low-refraction-index layer (the layer of the hollow silica particles) is equivalent to a layer of the localized hollow silica particles, which is formed by accumulation (or deposition) of the hollow silica particles in the side which is not adjacent the substrate film.

Incidentally, such a functional layer is not particularly limited to a specific one as long as the low-refraction-index layer is composed of the localized hollow silica particles. The hollow silica particles may be contained in a region other than the surface layer region. Incidentally, the low-refraction-index layer is usually formed by stacking or laminating one or more layer(s) of the hollow silica particles in the thickness direction of the functional layer.

The thickness of the low-refraction-index layer (or the surface layer which has an uneven surface structure and contains layer(s) of the hollow silica particles) may be, for example, about 70 to 120 nm, preferably about 80 to 100 nm, and more preferably about 85 to 95 nm. The thickness of the low-refraction-index layer can be regulated by selecting the particle diameter of the hollow silica particle and the surface treatment thereof. When the particle diameter of the hollow silica particle is large, the thickness of the low-refraction-index layer becomes large. In contrast, the particle diameter of the hollow silica particle is small, the thickness of the low-refraction-index layer becomes small. Incidentally, too a small thickness of the layer sometimes deviates from Fresnel's principle and deteriorates the anti-reflective performance or the light-room contrast. As a result, the screen image tends to have a whitish tinge. Too a large thickness of the layer also sometimes deviates from Fresnel's principle and deteriorates the anti-reflective performance or the light-room contrast. As a result, the screen image tends to have a whitish tinge.

The surface of the functional layer has a structure in which the hollow silica particles form most or all thereof. For example, the hollow silica particles may be present in not less than 90% (preferably not less than 93%, and more preferably not less than 95%) of a surface area of one side of the functional layer (particularly, a side which is not adjacent to the substrate film).

Incidentally, although the reason why the hollow silica particles accumulate or gather near the side (or front face) is unknown, the three following driving forces are probably involved in the accumulation or gathering:

(i) a hollow silica particle (e.g., a hollow silica particle surface-treated with a silane coupling agent or others) having a surface free energy lower than those of other components contained in the liquid coating composition moves from inside to outside of the coated layer,

(ii) a hollow silica particle (e.g., a hollow silica particle surface-treated with a silane coupling agent or others) having an affinity to a solvent contained in the liquid coating composition shifts (or comes) to a surface of the coated layer along with evaporation of the solvent, and

(iii) a hollow silica particle (e.g., a hollow silica particle surface-treated with a silane coupling agent or others) which is incompatible with all of resin components contained in the liquid coating composition is expelled from a resin phase (cured layer) of the coated layer along with reduction of the solvent content caused by drying of the coated layer, and expulsion of the hollow silica particle from the cured layer is further promoted along with progression of phase separation of the resin binder.

The localization of the hollow silica particles in the surface of the functional layer is probably caused by at least one of the above driving forces.

Incidentally, in formation of an anti-glare layer and a low-reflectance layer by separate coating steps according to the conventional art, the hollow silica particles are difficult to accumulate or gather along the uneven surface structure completely. For example, since after coating an anti-glare layer with a liquid coating composition containing the hollow silica particles, the liquid coating composition on the protruded regions particularly tends to moved to lower regions by leveling due to a surface tension or gravitational influence, it is difficult to coat the protruded regions with the hollow silica particles. Accordingly the reflectance is insufficiently decreased. Moreover, when a large amount of the hollow silica particles is used to coat the surface with the hollow silica particles completely, the surface is leveled off by the hollow silica particles. As a result, the anti-glare layer sometimes loses the anti-glareness.

In contrast, according to the present invention, the hollow silica particles move from inside to outside (surface) from the coating due to actions of the surface tension or phase separation after one coating step. The hollow silica particles can accumulate or gather to coat the uneven surface efficiently. In this case, as described above, since the hollow silica particles usually accumulate or gather along the uneven surface structure and efficiently impart anti-reflective function to the functional layer.

Moreover, for an anti-glare film having transparent fine particles protruded from a side (surface) opposite to the side adjacent to the substrate for forming an uneven surface structure, it is impossible to coat a region having the protruded transparent fine particle with the hollow silica particle. Therefore, the coating of the surface with the hollow silica particles is too insufficient to reduce the reflectance. Depending on an aspect of the hollow silica particle, the hollow silica particle sometimes aggregates together with a fine particle for forming an uneven surface structure.

In the contrast, for an anti-glare film having an uneven surface structure formed by phase separation (and convection) like the film of the present invention, the hollow silica particles can accumulate or gather near the surface efficiently because the film is free from foreign substances (e.g., the above-mentioned fine particle) which hinder the movement of the hollow silica particle. Therefore, such a film can have an enhanced anti-reflective function.

The thickness of the functional layer may be, for example, about 0.3 to 20 μm, preferably about 1 to 18 μm (e.g., about 3 to 16 μm), and usually about 5 to 15 μm (particularly about 7 to 13 μm).

The average inclination angle on the surface roughness of the functional film (or functional layer) may be within the range of about 0.5 to 1.5°, and may be, for example, about 0.7 to 10 and preferably about 0.8 to 0.950. The average inclination angle may be measured in accordance with JIS (Japanese Industrial Standards) B0601 by using a contacting profiling surface texture and contour measuring instrument (manufactured by Tokyo Seimitsu Co., Ltd., the trade name “surfcom570A”).

Moreover, the total light transmittance of the functional film (or functional layer) of the present invention is, for example, about 70 to 100%, preferably about 80 to 99%, and more preferably about 85 to 98% (particularly, about 88 to 97%).

Further, the haze of the functional film (or functional layer) may be selected from the range of about 1 to 10%, and is, for example, about 5 to 6.5% and preferably about 5.5 to 6%.

Incidentally, the haze and the total light transmittance can be measured with a NDH-5000W haze meter manufactured by Nippon Denshoku Industries Co., Ltd. in accordance with JIS K7105.

The image clarity (transmitted image clarity) of the functional film (or functional layer) of the present invention may be selected from the range of, in the case of using an optical slit of 0.5 mm width, about 10 to 70%, and is, for example, about 20 to 30% and preferably about 25 to 30%.

The image clarity is a measure for quantifying defocusing or distortion of a light transmitted through a film. The image clarity is obtained by measuring a light transmitted from a film through a movable optical slit, and calculating an amount of light in both a light part and a dark part of the optical slit. That is, in the case where a transmitted light is blurred by a film, the slit image formed on the optical slit becomes wider, and as a result the amount of light in the transmitting part is not more than 100%. On the other hand, in the non-transmitting part, the amount of light is not less than 0% due to leakage of light. The value C of the image clarity is defined by the following formula according to the maximum value M of the transmitted light in the transparent part of the optical slit, and the minimum value m of the transmitted light in the opaque part thereof.

C(%)=[(M−m)/(M+m)]×100

That is, the more the value C approaches 100%, the less the image is defocused by the anti-glare film [reference; Suga and Mitamura, Tosou Gijutsu, July, 1985].

There may be used an image clarity measuring apparatus (ICM-1DP, manufactured by Suga Test Instruments Co., Ltd.) as an apparatus for measuring the image clarity. There may be used an optical slit of 0.125 mm to 2 mm in width as the optical slit.

In the case where the image clarity is within the range, the outline (or contour) of reflection can be enough blurred so that excellent anti-glareness is imparted to the film. Too a high image clarity deteriorates an effect on inhibition of reflection. On the other hand, too a small image clarity inhibits the above-mentioned reflection but deteriorates clearness (or sharpness) of image.

[Process for Producing Functional Film]

The functional film (or functional layer) of the present invention may be produced by, for example, a step for coating (applying) a liquid coating composition (or a coating liquid or a mixture) containing the resin binder, the curable resin, and the hollow silica particle on (or to) a substrate (a substrate film) (a coating step), a step for drying a coated layer (wet coated layer) formed by the coating step (a drying step), and a step for curing the coated layer (dried coated layer) obtained by the drying step (a curing step). Incidentally, in the drying step phase separation (and convection phenomenon) of the plurality of resins usually occurs and forms an uneven surface structure. In the drying step of the coated layer, the hollow silica particles are moved toward a surface of the coated layer (a surface of the coated layer opposite the substrate) and accumulate or gather near the surface by the phase separation of the resins or the lower surface free energy of the silica particle as driving forces.

Specifically, the functional layer may be produced by coating a substrate (substrate film) with a mixture (particularly, a mixed solution) containing the resin binder, the curable resin, the hollow silica particle, and a solvent, generating a phase separation [particularly, a phase separation and a convection phenomenon (e.g., a cellular rotating convection)] in the wet coated layer in a step for drying the wet (undried) coated layer, and curing the dried layer. In the production process of the present invention, it is preferable that a solvent having a boiling point of not lower than 100° C. be used, the cellular rotating convection (convection cell) and phase separation be generated in the wet coated layer in the drying step, and then the coated layer be cured. Incidentally, when a separable substrate is used as the substrate, the coated layer, which constitutes the functional layer, may be separated from the substrate and used as a functional film.

(Cellular Rotating Convection)

In the present invention, the regular or periodic uneven surface is formed on a surface of the film by coating the liquid coating composition or mixture (solution) and usually raising the surface of the coated layer by a cellular rotating convection. In general, because of cooling a region near the surface of the coated layer by vaporization heat which is generated as evaporating the solvent to dryness, a temperature difference between the upper and lower layers (or regions) of the coated layer goes beyond the criticality. As a result the rotating convection is generated. Such a convection is referred to as Benard convection. Moreover, Benard convection is discovered by Benard and theoretically systematized by Rayleigh. Therefore the convection is also referred to as Benard-Rayleigh convection. The critical temperature difference (ΔT) is determined by the thickness of the coated layer (d), the coefficient of kinematic viscosity of the coated layer (solution) (ν), the thermal diffusibility of the coated layer (κ), the coefficient of cubical expansion of the coated layer (α), and the gravitational acceleration (g). The convection is generated when the Rayleigh number (Ra) defined by the following formula exceeds a certain critical value.

Ra=(α·g·ΔT·d³)/(κ·ν)

The generated convection regularly causes upstroke and downstroke repeatedly, so that the surface of the film has a regular or periodic unevenness arranged in a cell-like form. It is known that the aspect ratio of the cell (the coated direction/the thick direction) is about 2/1 to 3/1.

Moreover, the mode of the cellular rotating convection is not particularly limited to a specific one, and may be other convection mode. For example, the mode of the cellular rotating convection may be Marangoni convection (density convection) due to inhomogeneous distribution of surface tension.

(Combination of Convection and Phase Separation)

In the present invention, as mentioned above, the uneven surface is formed by generating the rotating convection of the mixture to give convection flow and concentration difference in solid content. Together with such a convection, components having phase separability from each other may be phase-separated by using a solution containing the components to form a phase-separation structure. Although the details of the mechanism of the combination of the convection and the phase separation are not yet elucidated, the mechanism can be presumed as follows.

By combining convection and phase separation, firstly convection cells a regenerated after coating. Next, phase separation is developed within each of the convection cells. The phase-separation structure grows larger with time, and the growth of the phase separation is stopped by the wall of the convection cell. As a result, an uneven pattern (or part) having a controlled interval depending on the size and arrangement of the cell and a good shape and height obtained by phase separation is formed. That is, an anti-glare film in which the shape, arrangement, and size of the uneven pattern (or part) are sufficiently controlled can be obtained.

(Liquid Coating Composition)

In the present invention, the convection or phase separation may be conducted by evaporating the solvent from the liquid coating composition (or mixture, particularly, solution). In particular, among components contained in the mixture (particularly, solution), the solvent is absolutely necessary to generate the convection stably. The reason for that is as follows: the solvent has an action to lower a surface temperature of a coated layer by vaporization heat due to evaporation and further has fluidity to allow the generated convection to flow or circulates without stagnation.

The solvent may be selected depending on the kinds and solubility of the resin binder and curable resin to be used. In the case of a mixed solvent, it is sufficient that the solvent can uniformly dissolve at least one solid content (at least one component selected from the group of consisting of the resin binder, the curable resin, a reaction initiator, and other additives). The solvent may include, for example, a ketone (e.g., acetone, methyl ethyl ketone, methyl isobutyl ketone, acetylacetone, acetoacetic acid ester, and cyclohexanone), an ether (e.g., diethyl ether, dioxane, and tetra hydrofuran), an aliphatic hydrocarbon (e.g., hexane), an alicyclic hydrocarbon (e.g., cyclohexane), an aromatic hydrocarbon (e.g., toluene and xylene), a carbon halide (e.g., dichloromethane and dichloroethane), an ester (e.g., methyl acetate, ethyl acetate, and butyl acetate), water, an alcohol (e.g., methanol, ethanol, propanol, isopropanol, butanol, cyclohexanol, diacetone alcohol, furfuryl alcohol, tetrahydrofurfuryl alcohol, ethylene glycol, propylene glycol, and hexylene glycol), a cellosolve (e.g., methyl cellosolve, ethyl cellosolve, butyl cellosolve, diethylene glycol monomethyl ether, diethylene glycolmonoethyl ether, and propylene glycol monomethyl ether), a cellosolve acetate, a sulfoxide (e.g., dimethyl sulfoxide), and an amide (e.g., dimethylformamide, and dimethylacetamide). These solvents may be used singly or in combination.

Incidentally, Japanese Patent Application Laid-Open No. 126495/2004 (JP-2004-126495A) discloses, as with the present invention, a process for producing a sheet, which comprises evaporating a solvent from a solution containing at least one polymer and at least one curable resin uniformly dissolved in the solvent. In the process, an anti-glare layer is produced by spinodal decomposition under an appropriate condition followed by curing the precursor. Although this document discloses a process for forming an uneven surface of the anti-glare film by phase separation due to spinodal decomposition, there is no description of cellular rotating convection.

In the present invention, in order to generate such a convection cell, it is preferred to use a solvent having a boiling point of not lower than 100° C. at an atmospheric pressure (which is sometimes referred to as a high-boiling solvent) as a solvent. Further, to generate the convection cell, the solvent preferably comprises at least two solvent components with different boiling points. Moreover, the boiling point of the solvent component having a higher boiling point may be not lower than 100° C. and is usually about 100 to 200° C., preferably about 105 to 150° C. and more preferably about 110 to 130° C. In particular, in order to use convection cell in combination with phase separation, the solvent preferably comprises at least one solvent component having a boiling point of not lower than 100° C. and at least one solvent component having a boiling point of lower than 100° C. (for example, a solvent component having a boiling point of about 35 to 99° C., preferably about 40 to 95° C., and more preferably about 50 to 85° C.) in combination. In the evaporation of such a mixed solvent, the solvent component having a lower boiling point generates a temperature difference between the upper and lower regions (or layers) of the coated layer due to evaporation, and the solvent component having a higher boiling point remains in the coated layer resulting in keeping of fluidity.

The solvent (or solvent component) having a boiling point of not lower than 100° C. at an atmospheric pressure may include, for example, an alcohol (e.g., a C₄₋₈alkyl alcohol such as butanol, pentyl alcohol or hexyl alcohol), an alkoxy alcohol (e.g., a C₁₋₆ alkoxyC₂₋₆alkyl alcohol such as methoxypropanol or butoxyethanol), an alkylene glycol (e.g., a C₂₋₄ alkylene glycol such as ethylene glycol or propylene glycol), and a ketone (e.g., cyclohexanone). These solvents may be used singly or in combination. Among them, a C₄₋₈alkyl alcohol such as butanol, a C₁₋₆ alkoxyC₂₋₆alkyl alcohol such as methoxypropanol or butoxyethanol, and a C₂₋₄ alkylene glycol such as ethylene glycol are preferred. These solvents may be used singly or in combination.

The ratio of the solvent components with different boiling points is not particularly limited to a specific one. In the use of a solvent component having a boiling point of not lower than 100° C. (a first solvent component) in combination with a solvent component having a boiling point lower than 100° C. (a second solvent component), the ratio of the first solvent component relative to the second component (when each of the first and second solvent components comprises a plurality of components, the ratio is defined as a weight ratio of the total first solvent components relative to the total second solvent components) may be, for example, about 10/90 to 90/10, preferably about 10/90 to 80/20, and more preferably about 15/85 to 70/30 (particularly about 20/80 to 60/40).

Moreover, when a liquid mixture or liquid coating composition is coated on a substrate (a transparent support), a solvent which does not dissolve, corrode or swell the transparent support may be selected according to the kinds of the transparent support. For example, when a triacetylcellulose film is employed as the transparent support, tetra hydrofuran, methyl ethyl ketone, isopropanol, toluene or the like is used as a solvent for the liquid mixture or the liquid coating composition and thus the functional layer can be formed without deteriorating properties of the film.

According to the present invention, in order to adjust the viscosity of the liquid coating composition (or mixture, particularly mixed solution) so that the shape of the uneven surface due to the convection is maintained and the generated convection circulates without stagnation, the solid content of the liquid coating composition may be, for example, about 5 to 50% by weight, preferably about 10 to 40% by weight, and more preferably about 15 to 35% by weight.

Incidentally, the proportion of the solid content in the liquid coating composition may be selected from the range as the same as that described above. For example, the proportion (weight ratio) of the resin binder relative to the curable resin (the former/the latter) may be about 5/95 to 95/5, preferably about 5/95 to 80/20, more preferably about 10/90 to 70/30, and particularly about 15/85 to 60/40. In particular, in the resin binder containing the cellulose derivative in whole or in part, the proportion (weight ratio) of the resin binder relative to the curable resin (the former/the latter) may be about 10/90 to 80/20, preferably about 20/80 to 70/30, and more preferably about 30/70 to 60/40 (e.g., about 35/65 to 55/45). Moreover, in the liquid coating composition, the proportion of the hollow silica particle in the whole solid content may be, for example, about 0.1 to 20% by weight, preferably about 0.2 to 15% by weight, more preferably about 0.3 to 10% by weight, and particularly about 0.5 to 5% by weight.

Such a liquid coating composition comprises the resin binder, the curable resin, and the hollow silica particle and is useful as a liquid coating composition for forming a functional film. Accordingly, the present invention also includes such a liquid coating composition.

(Coating Thickness)

In order to generate cellular rotating convection with a desired size, the coating thickness of the mixture or solution (the thickness of the undried coated layer) may be, for example, about 10 to 200 μm, preferably about 15 to 100 μm, and more preferably about 20 to 50 μm. Since the aspect ratio of the convection cell becomes 2 to 3, an uneven surface (or uneven pattern) in which the distance between adjacent projections is about 100 μm can be obtained by coating of the solution on the substrate at a coating thickness of about 30 to 80 μm. The thickness of the coated layer becomes thin due to evaporation of part of the solvent (or solvent component) with a lower boiling point in the solution, and concurrently the evaporation generates a temperature difference between the upper and the lower layers of the coated layer. As a result, cellular rotating convection having a size of about 50 μm can be generated.

(Coating Method)

The coating method may include a conventional manner, for example, a roll coater, an air knife coater, a blade coater, a rod coater, a reverse coater, a bar coater, a comma coater, a dip and squeeze coater, a die coater, a gravure coater, a microgravure coater, a silkscreen coater, a dipping method, a spraying method, and a spinner method. Among these methods, a bar coater or a gravure coater is used widely. In general, in the production of the anti-glare layer, cellular convection tends to be arranged in a machine direction (a MD direction of the film, or a moving direction of a coater such as bar coater).

(Drying Temperature)

After casting or coating the mixture (particularly, solution), the cellular rotating convection and phase separation are preferably induced by evaporating the solvent at a temperature lower than the boiling point of the solvent [for example, at a temperature lower than a boiling point of a solvent having a higher boiling point by about 1 to 120° C. (preferably by about 5 to 80° C. and particularly by about 10 to 60° C.)]. For example, depending on the boiling point of the solvent, the coated layer may be dried at a temperature of about 30 to 200° C. (e.g., about 30 to 100° C.), preferably about 40 to 120° C., and more preferably about 50 to 100° C.

Moreover, in order to generate the cellular rotating convection in the mixture, after casting or coating the solution on the support, it is preferable that the coated layer be put in a dryer after leaving the coated layer for a predetermined time (e.g., for about 1 second to 1 minute, preferably about 3 to 30 seconds, and more preferably about 5 to 20 seconds) at an ambient temperature or room temperature (e.g., about 0 to 40° C. and preferably about 5 to 30° C.) instead of putting the coated layer immediately in a dryer such as an oven for dryness.

Moreover, the dry air flow rate is not particularly limited to a specific one. In the case where the air flow rate is too high, the coated layer is dried and solidified before enough generation of rotating convection in the liquid coating composition. Accordingly, the dry air flow rate may be not higher than 50 m/minute (e.g., about 1 to 50 m/minute), preferably about 1 to 30 m/minute, and more preferably about 1 to 20 m/minute. The angle of the dry wind blown against the anti-glare film is not particularly limited to a specific one. For example, the angle may be parallel or perpendicular to the film.

In particular, for generating cellular rotating convection, it is preferable to dry the coated layer in the presence of a solvent, under an external force that does not inhibit formation of convection cell or an external force that does not inhibit convection in a phase separation region, for example, under a calm or a low air flow rate. Specifically, cellular rotating convection can be generated by heating the coated layer under a calm or low air flow rate (e.g., about 0.1 to 8 m/minute, preferably about 0.5 to 6 m/minute and more preferably about 1 to 5 m/minute) in a dryer having the above-mentioned drying temperature. Incidentally, instead of drying the film under a low air flow rate, the angle of the dry wind blown against the film may be adjusted to a low angle, for example, not larger than 70°, preferably about 5 to 60°, and more preferably about 10 to 50°. The heating time under a calm or low air flow rate may be, for example, about 1 second to 1 minute, preferably about 3 to 30 seconds, and more preferably about 5 to 20 seconds (particularly about 7 to 15 seconds).

(Curing Treatment)

After drying the mixture (solution), the coated layer is cured or crosslinked by heat or an actinic ray (e.g., an ultra violet ray, and an electron beam). The curing process may be selected depending on the kinds of the curable resin, and a curing process by light irradiation such as an ultra violet ray or an electron beam is usually employed. The widely used light source for exposure is usually an ultra violet irradiation equipment. If necessary, light irradiation may be carried out under an inert gas atmosphere.

[Optical Member]

The functional film of the present invention has uniform and high-definition (or high-grade) anti-glareness because of an uneven surface in which each raised part is uniformly controlled by phase separation (and cellular rotating convection) and a low-refraction-index layer having accumulated hollow silica particles as the outermost layer. Further, the functional film of the present invention has a high abrasion resistance (hardcoat property) and substantially contains no scattering medium within the film. Accordingly, the functional film realizes a high light-room contrast without having a whitish tinge due to an exterior light. Therefore, the functional film of the present invention is suitable for application of an optical member or others, and the above-mentioned support may also comprise a transparent polymer film for forming various optical members. The functional film obtained in combination with the transparent polymer film may be directly used as an optical member, or may form an optical member in combination with an optical element [for example, a variety of optical elements to be disposed into a light path, e.g., a polarizing plate, an optical retardation plate (or phase plate), and a light guide plate (or light guide)]. That is, the functional film may be disposed or laminated on at least one light path surface of an optical element. For example, the functional film may be laminated on at least one surface of the optical retardation plate, or may be disposed or laminated on an emerging surface (or emerge surface) of the light guide plate.

Since the functional film has abrasion, the functional film serves as a protective film. The functional film of the present invention is, therefore, suitably used as at least one of two protective films for a polarizing plate to produce a laminate (optical member), that is, the functional film is laminated on at least one surface of a polarizing plate to produce a laminate (optical member).

[Display Apparatus]

The functional film of the present invention can be utilized for various display apparatuses or devices such as a liquid crystal display (LCD) apparatus, a cathode ray tube display, an organic or inorganic EL display, a field emission display (FED), a surface-conduction electron-emitter display (SED), a rear projection television display, a plasma display (PDP), and a touch panel-equipped display device. Therefore, the present invention also includes a display apparatus comprising the functional film.

These display apparatuses comprise the functional film or the optical member (particularly, e.g., a laminate of a polarizing plate and an anti-glare film) as an optical element. In particular, the functional film can be preferably used for a liquid crystal display apparatus and others because the functional film can inhibit reflection even in the case of being attached to a large-screen liquid crystal display apparatus such as a high-definition or high-definitional liquid crystal display.

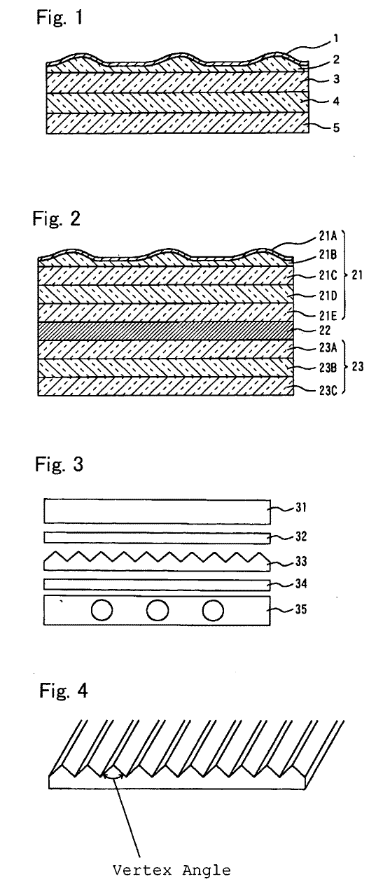

FIG. 1 is a schematic cross-sectional view of an optical member comprising a functional film in accordance with an embodiment of the present invention and a polarizing plate and having a laminated structure. The optical member comprises a polarizing layer 4 and an anti-glare layer 2 having a low-refraction-index layer 1 as a surface layer (upper layer) thereof. In the low-refraction-index layer 1 hollow silica particles accumulate or gather. The polarizing layer 4 has protective layers 3 and 5 on both sides. The anti-glare layer 2 is formed on the protective layer 3. In the optical member, the polarizing layer 4 is a film obtained by drawing a polyvinyl alcohol and dyeing the drawn polyvinyl alcohol with an iodine compound or a dye. Each of the protective layers 3 and 5 comprises a transparent resin, for example, a cellulose acetate-series resin such as a triacetylcellulose, a polyester-series resin, a polycarbonate-series resin, a polysulfone-series resin, a polyarylate-series resin, an acrylic resin such as a methyl methacrylate-series resin, and a cyclic polyolefinic resin such as a norbornene resin.

Incidentally, the liquid crystal display apparatus may be a reflection-mode (or reflective) liquid crystal display apparatus using an external light (or outside light) for illuminating a display unit comprising a liquid crystal cell, or may be a transmission-mode (or transmissive) liquid crystal display apparatus comprising a backlight unit for illuminating a display unit. In the reflection-mode liquid crystal display apparatus, the display unit can be illuminated by taking in an incident light from the outside through the display unit and reflecting the transmitted incident light by a reflective member. In the reflection-mode liquid crystal display apparatus, the anti-glare film or optical member (particularly a laminate of a polarizing plate and an anti-glare film) can be disposed in a light path in front of the reflective member. For example, the functional film or optical member can be disposed or laminated, for example, between the reflective member and the display unit, or on the front surface of the display unit.

A transmissive liquid crystal display apparatus such as a liquid crystal television mainly employs a direct backlight unit. The backlight unit comprises a diffusion plate for the purpose of diffusing a light from a light source (e.g., a tubular light source such as a cold cathode tube or a hot cathode tube, and a point light source such as a light emitting diode) to make the brightness of the light uniform. Further, a prism sheet may be disposed on the front surface of the diffusion plate to increase the front luminance. The prism sheet has triangular prism units, each having a cross section which is an approximately isosceles triangle, and the units are arranged in parallel with each other to form a plurality of prism lines. The prism sheet comprises a transparent resin such as an olefinic resin (e.g., a cyclic olefin), a polycarbonate-series resin, or a poly(methylmethacrylate)-series resin. As the prism sheet, for example, “BEF series” manufactured by Sumitomo 3M Limited and others are commercially available. In the present invention, the prism sheet is not particularly limited to a specific one as long as the prism unit has across section which is an approximately isosceles triangle. A sheet having a sharp-pointed vertical angle of the isosceles triangle is preferable to a sheet having a rounded vertical angle of the isosceles triangle. Specifically, even in the case where the vertical angle is rounded, the radius of the curved surface may be, for example, not larger than 5 μm, and preferably not larger than 1 μm. The vertical angle is usually almost 90°.

Further, a reflective polarizing sheet may be disposed on the front surface of the prism sheet. The reflective polarizing sheet may be a multilayer membrane comprising a polyethylene-series resin and plays a role in the improvement of the effective utilization of the light reflected by the film. As the reflective polarizing sheet, for example, the trade name “DBEF” (manufactured by Sumitomo 3M Limited) and others have been put on the market.

In the liquid crystal display apparatus, the liquid crystal mode is not particularly limited to a specific one. For example, the liquid crystal mode may be aVA (Vertically Aligned) mode, a TN (Twisted Nematic) mode, an STN (Super Twisted Nematic) mode, an IPS mode (In-Plane Switching), and an OCB (Optical Compensated Bend) mode.

In the functional film of the present invention, a combination use of the plurality of resins capable of phase-separating from each other, the curable resin, and the hollow silica particle imparts a hardcoat property, an anti-reflective property, and anti-glareness, which have been difficult to achieve together, to a single coated layer. Therefore, such a functional film inhibits reflection of an exterior light or dazzle and can display a black image (an image having a high light-room contrast) even under an exterior light. Moreover, in order to meet a bright (high-brightness) and a high-contrast image required for a liquid crystal display apparatus (liquid crystal panel), a combination use of the functional film of the present invention and the prism sheet having a vertex angle of almost 90° can remarkably improve the luminance by not less than 10%.

Further, according to the present invention, a functional film having a hardcoat property, an anti-reflective property, and anti-glareness can be produced by a simple and low-cost process, that is, a single-coating on a substrate film.

Moreover, the liquid coating composition of the present invention is useful for obtaining a functional film having a hardcoat property, an anti-reflective property, and anti-glareness.

The present invention is useful for a variety of applications which require anti-glareness, a hardcoat property, and a light-scattering property, e.g., for the above-mentioned optical member or display apparatus (or an optical element thereof) such as a liquid crystal display apparatus (in particular, a high-definition or high-definitional display apparatus). In particular, a combination use of the anti-glare film and the liquid crystal panel improves the light-room contrast and realizes a neutral reflected color in a display of black. Therefore, the functional film (or anti-glare film) of the present invention is particularly suitable as a functional film used for a liquid crystal display apparatus, a PDP, an organic electroluminescence (EL), and others.

### EXAMPLES

The following examples are intended to describe this invention in further detail and should by no means be interpreted as defining the scope of the invention.

Anti-glare films obtained in Examples and Reference Examples were evaluated by the following items.

[Total Light Transmittance and Haze]

The total light transmittance and the haze were measured by using a haze meter (manufactured by Nippon Denshoku Industries Co., Ltd., the trade name “NDH-5000W”).

[Image (Transmitted Image) Clarity]

The image clarity of the anti-glare film was measured in accordance with JIS K7105 by using an image clarity measuring apparatus (manufactured by Suga Test Instruments Co., Ltd., the trade name “ICM-1DP”) provided with an optical slit (the slit width=0.5 mm). The image clarity was measured in the following method: the film was installed so that the machine direction of the film was parallel to the teeth direction of the optical slit.

A black film was bonded on the reverse side of the anti-glare film. A photograph of the surface of the anti-glare film was taken by using a laser reflecting microscope, and the presence of an uneven surface structure was observed.

[Pencil Hardness]

The pencil hardness of the anti-glare film was evaluated in accordance with JIS K5400 as an index of hardness.

[Abrasion Resistance]

A #0000 steel wool was allowed to go back and forth on the anti-glare film ten times at a weighting of 250 g/cm². Then the number of abrasions on the film was counted, and the abrasion resistance was evaluated based on the following criteria.

“A”: The number of abrasions is not more than 2.

“B”: The number of abrasions is 3 or 4.

“C”: The number of abrasions is 5 or 6.

“D”: The number of abrasions is not less than 7.

[Mounting Evaluation]

As shown in FIG. 2, a liquid crystal panel was made by bonding polarizing plates 21 and 23 on both sides of a liquid crystal cell 22, respectively, so that the absorption axes of these polarizing plates were at a right angle to each other. The polarizing plate 21 comprised a functional layer 21B, a substrate film (protective layer) 21C, a polarizing layer 21D, and a protective layer 21E. The functional layer 21B was laminated on a first side of the substrate film 21C, and the polarizing layer 21D and the protective layer 21E were laminated on a second side of the substrate film 21C. In the functional layer 21B, hollow silica particles accumulated or gathered near a surface (or upper surface) of the functional layer 21B to form a particle layer (low-refraction-index layer) 21A. The polarizing plate 23 comprised a polarizing layer 23B, and protective layers 23A and 23C. The protective layers 23A and 23C were formed on first and second sides of the polarizing layer 23B, respectively.

Incidentally, the functional film shown in FIG. 2 corresponded to the functional film (anti-glare film) obtained in each of Examples and was used for the liquid crystal panel in Examples. In the meantime, in Reference Examples, the functional film shown in FIG. 2 corresponded to the functional film obtained in each of Reference Examples and was used for the liquid crystal panel.

With the use of the liquid crystal panel shown in FIG. 2 (a liquid crystal panel 31), as shown in FIG. 3, a diffusion film 34, a prism sheet 33, a reflective polarizing film 32, and the liquid crystal panel 31 were arranged in this order on a backlight source 35, and a liquid crystal display apparatus comprising the liquid crystal panel and a drive circuit of a backlight was produced. That is, in the liquid crystal display apparatus, the anti-glare film and the polarizing plate 21 were laminated on a front side of the liquid crystal panel 31, and another polarizing plate 23 was laminated on a back side of the panel 31 so that the absorption axes of the polarizing plate and the polarizing layer were at a right angle to each other. In the liquid crystal display apparatus, a vertically aligned mode (VA mode) was applied as the liquid crystal mode. The liquid crystal panel of the vertically aligned mode displays a black display at the state that the in-plane phase difference is almost zero. By using such a liquid crystal display apparatus, a voltage was applied to the liquid crystal panel, and the following evaluation was made.

Incidentally, FIG. 4 shows a schematic perspective view of the prism sheet 33. In the sheet, the vertex angle of the isosceles triangle of the prism part is almost 900. For example, the trade name “BEFIII” manufactured by Sumitomo 3M Limited corresponds to such a prism sheet and is commercially available. On the other hand, as a prism sheet having a rounded vertical angle of the isosceles triangle, the trade name “RBEF” manufactured by Sumitomo 3M Limited is commercially available.

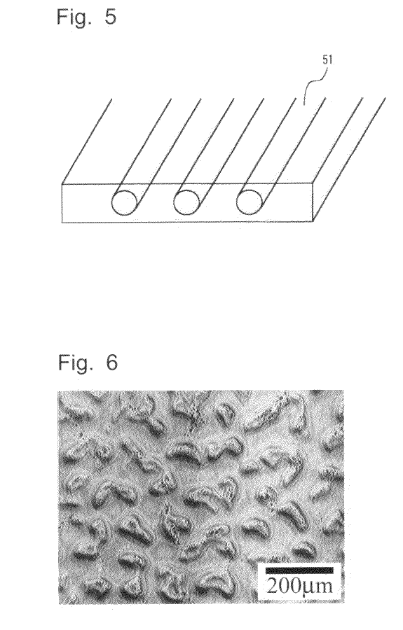

Moreover, FIG. 5 shows a schematic perspective view of the backlight source 35. This backlight source is a direct backlight unit in which tubular light sources 51 are disposed in parallel with each other.

(Anti-Glareness)

A fluorescent lamp having an exposed (uncovered) fluorescent tube was used. The reflected light of the lamp on the panel surface was visually observed, and the blurring of the reflected outline of the fluorescent tube was evaluated on the basis of the following criteria.

“A”: No reflected outline of the fluorescent lamp is observed.

“B”: The reflected outline of the fluorescent lamp is slightly observed, but it is negligible.

“C”: The reflected outline of the fluorescent lamp is observed, and it is slightly considerable.

“D”: The strongly reflected outline of the fluorescent lamp is observed, and it is very considerable.

(Darkness of Reflected Image)

An observer's face was reflected on the panel surface in a light-room environment. The reflected image was visually observed, and the darkness of the reflected image and the distinction of the facial features were evaluated on the basis of the following criteria.

“A”: The reflected image of the face is sufficiently dark, and no reflected outline of the face is observed.

“B”: The reflected image of the face is slightly observed, but the facial features cannot be distinguished.

“C”: The reflected image of the face is observed, and the facial features are distinguished.

“D”: The strongly reflected image of the face is observed, and is very considerable.

(Blackness)

The liquid crystal panel was installed so that the surface of the panel was almost perpendicular to the floor. In a light-room environment having an illuminance of not less than 500 lux (lx) and having white walls on either side of the panel, the surface of the panel in a state of the black display was visually observed whether the surface appeared black, and evaluated on the basis of the following criteria.

“A”: The surface sufficiently appears black.

“B”: The surface appears black.

“C”: The surface does not appear very black.

“D”: The surface hardly appears black.

(Brightness of White Display)

Only a white color was displayed in the liquid crystal panel, and the brightness was visually observed, and evaluated on the basis of the following criteria.

“A”: very bright

“B”: bright

“C”: not very bright

“D”: not bright at all

Here are formulations of hollow silica particle dispersions and liquid coating compositions used in Examples and Reference Examples and preparation processes thereof.

(Hollow Silica Dispersion)

A dispersion having hollow silica particles (having a mean particle diameter of 60 nm and a refraction index of 1.26) dispersed in methyl ethyl ketone in a proportion of 20% by weight (manufactured by JGC Catalysts and Chemicals Ltd., “SH-1151SIV”) was used.

(Preparation of Liquid Coating Composition 1)

In a mixed solvent containing 35.1 parts by weight of methylethylketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”) , and 2.5 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 2)

In a mixed solvent containing 42.5 parts by weight of methylethylketone (MEK) (boiling point: 80° C.), 7.4 parts by weight of 1-butanol (BuOH) (boiling point: 113° C.), and 14.3 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000, manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”) , and 2.5 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 3)

In a mixed solvent containing 49.9 parts by weight of methylethylketone (MEK) (boiling point: 80° C.), 7.4 parts by weight of 1-butanol (BuOH) (boiling point: 113° C.), and 6.9 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”), and 2.5 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 4)

In a mixed solvent containing 34.1 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”) , and 3.7 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 5)

In a mixed solvent containing 36.0 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”), and 1.2 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 6)

In a mixed solvent containing 37.0 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.3 parts by weight of a polyfunctional acrylic UV-curable monomer (manufactured by DAICEL-CYTEC Company, Ltd., “DPHA”), 5.7 parts by weight of a polyfunctional acrylic UV-curable monomer (manufactured by DAICEL-CYTEC Company, Ltd., “PETIA”), 0.9 part by weight of a photopolymerization initiator (manufactured by Ciba Specialty Chemicals K.K., “IRGACURE 184”), and 0.4 part by weight of a photopolymerization initiator (manufactured by Ciba Specialty Chemicals K.K., “IRGACURE 907”). Incidentally, the cellulose acetate propionate and the acrylic resin are incompatible with each other, and the concentration of the resulting solution is accompanied by phase separability.

(Preparation of Liquid Coating Composition 7)

In a mixed solvent containing 32.1 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 14.1 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 1.5 parts by weight of a cellulose acetate propionate (acetylation degree=2.5%, propionylation degree=46%, number average molecular weight in terms of polystyrene: 75,000; manufactured by Eastman, Ltd., “CAP-482-20”), 11.4 parts by weight of a polyfunctional acrylic UV-curable monomer (manufactured by DAICEL-CYTEC Company, Ltd., “DPHA”), 2.5 parts by weight of a polyfunctional acrylic UV-curable monomer (manufactured by DAICEL-CYTEC Company, Ltd., “PETIA”), 6.2 parts by weight of a polyfunctional hybrid UV-curing agent (manufactured by JSR, “Z7501”), 0.9 part by weight of a photopolymerization initiator (manufactured by Ciba Specialty Chemicals K.K., “IRGACURE 184”), 0.4 part by weight of a photopolymerization initiator (manufactured by Ciba Specialty Chemicals K.K., “IRGACURE 907”), and 2.5 parts by weight of the hollow silica dispersion (solid content: 20% by weight). Incidentally, the cellulose acetate propionate and the acrylic resin are incompatible with each other, and the concentration of the resulting solution is accompanied by phase separability.

(Preparation of Liquid Coating Composition 8)

In a mixed solvent containing 32.1 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 32.6 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution) and 2.5 parts by weight of the hollow silica dispersion (solid content: 20% by weight). Incidentally, the concentration of the resulting solution is not accompanied by phase separability because the liquid coating composition contains only one resin.

(Preparation of Liquid Coating Composition 9)

In a mixed solvent containing 32.1 parts by weight of methyl ethyl ketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 32.6 parts by weight of a polyfunctional acrylic UV-curable monomer (manufactured by DAICEL-CYTEC Company, Ltd., “DPHA”) and 2.5 parts by weight of the hollow silica dispersion (solid content: 20% by weight). Incidentally, the concentration of the resulting solution is not accompanied by phase separability because the liquid coating composition contains only one resin.

(Preparation of Liquid Coating Composition 10)

In a mixed solvent containing 39.6 parts by weight of methylethylketone (MEK) (boiling point: 80° C.), 7.4 parts by weight of 1-butanol (BuOH) (boiling point: 113° C.), and 21.8 parts by weight of 1-methoxy-2-propanol (boiling point: 119° C.) were dissolved 12.6 parts by weight of an acrylic resin having a polymerizable unsaturated group(s) in a side chain thereof (manufactured by Daicel Chemical Industries, Ltd., “CYCLOMER-P”, solid content: 44% by weight, 1-methoxy-2-propanol solution), 20.0 parts by weight of a polyfunctional acrylic UV-curable monomer (manufactured by DAICEL-CYTEC Company, Ltd., “DPHA”), and 2.5 parts by weight of the hollow silica dispersion (solid content: 20% by weight). Incidentally, the acrylic resin and the polyfunctional acrylic UV-curable monomer are highly compatible with each other, and the concentration of the resulting solution is not accompanied by phase separability.

### Example 1

The liquid coating composition 1 was coated on a cellulose triacetate film (manufactured by FUJIFILM Corporation, the trade name “TD80UL G”, thickness: 80 μm) by a continuous mechanical coating. The coating manner was a microgravure manner. A coat layer having a thickness of about 11 μm and an uneven surface was formed by using a drying furnace that was able to control a drying condition of a first zone and that of a second zone separately. After drying by the drying furnace, the obtained coat layer was subjected to UV curing treatment by irradiating ultra violet rays from a metal halide lump (manufactured by Eyegraphics Co., Ltd.) for about 30 seconds to form a functional film having a hardcoat property and an uneven surface structure. The characteristics of the resulting film are shown in Table 1.

Incidentally, in the mounting evaluation, a sheet (the trade name “RBEF” manufactured by Sumitomo 3M Limited) was used as a prism sheet.

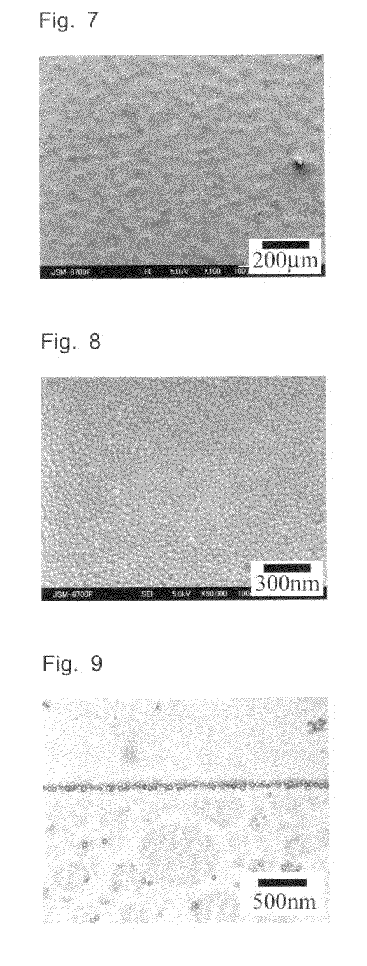

Next, the laser reflection microphotograph of the uneven surface of the film is shown in FIG. 6. As apparent from FIG. 6, it is clear that the uneven surface is formed by convection and phase separation. Moreover, the scanning electron microphotograph (SEM) is shown in FIG. 7, and an expanded photograph of part of FIG. 7. is shown in FIG. 8. These SEM photographs reveal that the whole surface is coated with the hollow silica particle in spite of the uneven structure. Further, FIG. 9 shows a transmission electron microphotograph (TEM) of a cross section near a surface of the functional film. The existence of a layer having the hollow silica particles localized therein and having a thickness of about 100 nm was observed in the boundary region between the air and the functional layer (anti-glare layer) by the TEM photograph.

### Example 2

The continuous mechanical coating on the cellulose triacetate film was conducted in the same manner as in Example 1 except for using the liquid coating composition 2 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Example 3

The continuous mechanical coating on the cellulose triacetate film was conducted in the same manner as in Example 1 except for using the liquid coating composition 3 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Example 4

The continuous mechanical coating on the cellulose triacetate film was conducted in the same manner as in Example 1 except for using the liquid coating composition 4 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Example 5

The continuous mechanical coating on the cellulose triacetate film was conducted in the same manner as in Example 1 except for using the liquid coating composition 5 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Reference Example 1

The continuous mechanical coating on the cellulose triacetate film was conducted in the same manner as in Example 1 except for using the liquid coating composition 6 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Reference Example 2

The continuous mechanical coating on the cellulose triacetate film was conducted in the same manner as in Example 1 except for using the liquid coating composition 7 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

### Reference Example 3

The continuous mechanical coating on the cellulose triacetate film was conducted in the same manner as in Example 1 except for using the liquid coating composition 8 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property but not having an uneven surface structure. The characteristics of the resulting film are shown in Table 1.

### Reference Example 4

The continuous mechanical coating on the cellulose triacetate film was conducted in the same manner as in Example 1 except for using the liquid coating composition 9 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property but not having an uneven surface structure. The characteristics of the resulting film are shown in Table 1.

### Reference Example 5

The continuous mechanical coating on the triacetylcellulose film was conducted in the same manner as in Example 1 except for using the liquid coating composition 10 instead of the liquid coating composition 1, and a coat layer having a thickness of about 11 μm was formed. After drying by the drying furnace, the obtained coat layer was subjected to UV curing treatment in the same manner as in Example 1 to form a functional film having a hardcoat property and an uneven surface structure. The characteristics of the resulting film are shown in Table 1.

TABLE 1

| | Examples | | | | | Reference Examples | | | | |
|---|---|---|---|---|---|---|---|---|---|---|
| | 1 | 2 | 3 | 4 | 5 | 1 | 2 | 3 | 4 | 5 |
| Uneven surface | formed | formed | formed | formed | formed | formed | formed | not | not | formed |
| | | | | | | | | formed | formed | |
| Phase separability of solution | present | present | present | present | present | present | present | absent | absent | absent |
| Characteristics of | | | | | | | | | | |
| functional film | | | | | | | | | | |
| Total light transmittance (%) | 93.5% | 93.2% | 92.8% | 92.4% | 93.1% | 91.8% | 91.8% | 91.5% | 91.8% | 91.9% |
| Haze (%) | 6.0% | 6.8% | 7.5% | 9.3% | 5.8% | 5.5% | 5.5% | 1.0% | 0.9% | 1.1% |
| Image clarity (%) | 40.0% | 43.0% | 39.0% | 45.0% | 38.0% | 41.0% | 39.0% | 92.0% | 94.0% | 65.0% |
| Reflectance (%) | 1.5% | 1.9% | 2.4% | 1.8% | 2.0% | 4.2% | 4.3% | 4.3% | 4.4% | 4.1% |
| Liquid coating composition | | | | | | | | | | |
| Hollow silica (% by weight) | 2.0% | 2.0% | 2.0% | 3.0% | 1.0% | 0.0% | 2.0% | 2.0% | 2.0% | 2.0% |
| in resin solid content | | | | | | | | | | |
| High-boiling solvent (% by | 50.0% | 40.0% | 30.0% | 50.0% | 50.0% | 50.0% | 50.0% | 50.0% | 50.0% | 50.0% |
| weight) in whole solvent | | | | | | | | | | |
| Performance | | | | | | | | | | |
| Anti-glareness | A | A | A | A | A | A | A | D | D | B |
| Darkness of reflected image | A | A | B | A | B | D | D | D | D | D |
| Blackness | A | B | B | C | B | D | D | D | D | D |
| Brightness of white display | A | A | A | A | A | B | B | A | A | A |
| Pencil hardness | 4H | 4H | 4H | 4H | 4H | 3H | 3H | — | — | — |
| Abrasion resistance | A | A | A | A | A | B | C | — | — | — |

As apparent from the results of Table 1, the anti-glare films of Examples 1 to 5 have a sufficiently low reflectance, a high contrast in a light-room and a dark-room, and a high anti-glareness. In addition, these films have a sufficiently high hardcoat property. Specifically, the results of Examples 1 to 3 show that the reflectance decreases in a film made from a liquid coating composition containing a larger amount of the solvent having a high boiling point. However, it is necessary to regulate the amount of the solvent having a high boiling point carefully because an excessive amount of the solvent results in an insufficient drying of the film, thereby deteriorating mechanical properties or durability of the film.

On the other hand, since a small amount of the hollow silica particle to be added cannot completely coat the surface of the film, the effects of the hollow silica particle on reflectance are decreased. In contrast, when the amount of the hollow silica particle to be added is too large, the hollow silica particle remains not in the surface of the film but inside of the film. The remaining particle becomes a source of the internal haze, and as shown in the results of Example 4, the blackness of the image is somewhat deteriorated. The functional film of Reference Example 1 has a sufficient anti-glareness. However, the film has a high reflectance and a low contrast in a light-room because of a lack of the hollow silica particle. From the results of Reference Example 2, the reason for an insufficient low reflectance is probably that the polyfunctional hybrid UV-curing agent (manufactured by JSR, “Z7510”) hinders localization of the hollow silica particles in the film surface because the UV-curing agent which has a surface free energy presumably lower than that of the hollow silica particle moves towards the film surface.

Reference Examples 3 and 4, in which phase separation was not induced in the drying process, did not show reduction of reflectance because the hollow silica particles used were not localized in the film surface. Moreover, Reference Example 5, in which phase separation was not induced in the drying process as well as Reference Examples 3 and 4, did not show reduction of reflectance and had a low contrast in a light-room because the hollow silica particles did not accumulate or gather along the formed uneven surface structure. According to comparison between the results of Example 1 and those of Reference Examples 3 to 5, the resins probably held off the hollow silica particles due to the induced phase separation of the resins, whereby the hollow silica particles moved toward the surface (or upper surface) direction of the film. That is, the phase separation of the resins probably plays an important role in localization of the hollow silica particles in the film surface.

What is claimed is:

1. A functional film comprising a substrate film and a functional layer formed on the substrate film,
wherein the functional layer has a first side and a second side adjacent to the substrate film,
the functional layer is a cured layer of a coated layer,
the coated layer contains a resin binder comprising a plurality of resins capable of phase-separating from each other, a curable resin, and a hollow silica particle, and
the hollow silica particles accumulate or gather near the first side of the functional layer.

2. A functional film according to claim 1, wherein the plurality of resins contain at least a cellulose derivative.

3. A functional film according to claim 1, wherein at least one polymer of the plurality of resins has a functional group reactive to the curable resin.

4. A functional film according to claim 1, wherein the plurality of resins comprise
a cellulose ester and
at least one resin selected from the group consisting of a (meth)acrylic resin, an alicyclic olefinic resin, and a polyester-series resin, having a functional group reactive to the curable resin at a side chain thereof.

5. A functional film according to claim 1, wherein the resin binder has phase-separability from the curable resin.

6. A functional film according to claim 1, wherein the hollow silica particles have a mean particle diameter of 50 to 70 nm and a refraction index of 1.20 to 1.25.

7. A functional film according to claim 1, wherein the first side of the functional layer has an uneven surface structure, and the hollow silica particles accumulate or gather along the uneven surface structure.

8. A functional film according to claim 7, wherein the uneven structure is formed by phase separation and convection phenomenon of the plurality of resins.

9. A functional film according to claim 1, wherein the hollow silica particles are present in not less than 90% of a surface area of the first side of the functional layer.

10. A process for producing a functional film recited in claim 1, which comprises
a coating step for coating a substrate film with a liquid coating composition containing a resin binder comprising a plurality of resins capable of phase-separating from each other, a curable resin, and a hollow silica particle,
a drying step for drying the resulting coated layer, and
a curing step for curing the dried coated layer.

11. A process according to claim 10, wherein the liquid coating composition contains at least two kinds of solvents with different boiling points.

12. A process according to claim 10, wherein the liquid coating composition contains at least one solvent having a boiling point not lower than 100° C. and at least one solvent having a boiling point lower than 100° C.

13. A process according to claim 10, wherein, in the curing step, the coated layer is irradiated with at least one selected from the group consisting of an actinic ray and heat.

14. A liquid coating composition for obtaining a functional film containing
a resin binder comprising a plurality of resins capable of phase-separating from each other,
a curable resin, and
a hollow silica particle.

15. A display apparatus provided with a functional film recited in claim 1.

16. A display apparatus according to claim 15, which is selected from the group consisting of a liquid crystal display, a cathode ray tube display, a plasma display, and a touch panel-equipped input device.
